(19) United States
(12) Patent Application Publication
(10) Pub. No.: US 2023/0221994 A1
(43) Pub. Date: Jul. 13, 2023

(54) DYNAMIC UNCOMPRESSION FOR CHANNEL-SEPARABLE OPERATION IN NEURAL NETWORK

(71) Applicants: Arnab Raha, San Jose, CA (US); Deepak Abraham Mathaikutty, Chandler, AZ (US); Raymond Jit-Hung Sung, San Francisco, CA (US); Umer Iftikhar Cheema, Hillsboro, OR (US); Dinakar Kondru, Frisco, TX (US); Soumendu Kumar Ghosh, Lafayette, IN (US)

(72) Inventors: Arnab Raha, San Jose, CA (US); Deepak Abraham Mathaikutty, Chandler, AZ (US); Raymond Jit-Hung Sung, San Francisco, CA (US); Umer Iftikhar Cheema, Hillsboro, OR (US); Dinakar Kondru, Frisco, TX (US); Soumendu Kumar Ghosh, Lafayette, IN (US)

(21) Appl. No.: 18/184,921

(22) Filed: Mar. 16, 2023

(51) Int. Cl. G06F 9/50; G06F 9/54

(52) U.S. Cl. CPC G06F 9/5027; G06F 9/54

(57) ABSTRACT

A compute block can dynamically uncompress compressed data for executing a channel-separable operation. The compressed data includes one or more nonzero-valued data elements. The compressed data may be stored in a datastore along with a sparsity bitmap of an input operand including the compressed data. An uncompressing module may determine whether the input operand includes any zero-valued data element, e.g., by determining whether the sparsity bitmap includes a zero-valued bit. After determining that the sparsity bitmap includes a zero-valued bit, the uncompressing module inserts a zero-valued data element into the compressed data based on a position of the bit in the sparsity bitmap and generates uncompressed data and update the sparsity bitmap so that all the bits become ones. The uncompressed dense data is transmitted to one or more processing elements (PE) in the compute block for computing an output operand based on the uncompressed dense data.

### TECHNICAL FIELD

This disclosure relates generally to neural networks, and more specifically, dynamic uncompression for channel-separable operations in deep neural networks (DNNs).

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as a large amount of data to read and write. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

Figure FIG. 1 illustrates an example DNN, in accordance with various embodiments.

FIG. 2 is a block diagram of a DNN accelerator, in accordance with various embodiments.

FIG. 3 is a block diagram of a compute block, in accordance with various embodiments.

FIG. 4 illustrates a datastore 400 implemented with uncompressing modules 420, in accordance with various embodiments.

FIG. 5 illustrates a dynamic uncompressing process in an uncompressing module comprising two expansion function units, in accordance with various embodiments.

FIG. 6 illustrates input and output of an uncompressing module for four load rounds, in accordance with various embodiments.

FIG. 7 illustrates a DNN executed without dynamic uncompression in accordance with various embodiments.

FIG. 8 illustrates a DNN executed with dynamic uncompression, in accordance with various embodiments.

FIG. 9 illustrates an example standard convolution, in accordance with various embodiments.

FIG. 10 illustrates an example depthwise convolution, in accordance with various embodiments.

FIG. 11 illustrates an example group convolution, in accordance with various embodiments.

FIG. 12 illustrates an example depthwise convolution in a processing element (PE), in accordance with various embodiments.

FIG. 13 illustrates an example channel-separable pooling operation in a PE, in accordance with various embodiments.

FIG. 14 illustrates another example channel-separable pooling operation in a PE, in accordance with various embodiments.

FIG. 15 illustrates an example channel-separable elementwise addition in a PE, in accordance with various embodiments.

FIG. 16 illustrates another example channel-separable elementwise addition in a PE, in accordance with various embodiments.

FIG. 17 illustrates an example channel-separable elementwise multiplication in a PE, in accordance with various embodiments.

FIG. 18 illustrates a PE array, in accordance with various embodiments.

FIG. 19 is a block diagram of a PE, in accordance with various embodiments.

FIG. 20 is a flowchart showing a method of dynamic uncompression for channel-separable operations, in accordance with various embodiments.

FIG. 21 is a block diagram of an example computing device, in accordance with various embodiments.

### DETAILED DESCRIPTION

### Overview

The last decade has witnessed a rapid rise in AI (artificial intelligence) based data processing, particularly based on DNNs. DNNs are widely used in the domains of computer vision, speech recognition, image, and video processing mainly due to their ability to achieve beyond human-level accuracy. DNNs The significant improvements in DNN model size and accuracy coupled with the rapid increase in computing power of execution platforms have led to the adoption of DNN applications even within resource constrained mobile and edge devices that have limited energy availability.

A DNN layer may include one or more deep learning operations, such as convolution, pooling, elementwise operation, linear operation, nonlinear operation, and so on. A deep learning operation in a DNN may be performed on one or more internal parameters of the DNNs (e.g., weights), which are determined during the training phase, and one or more activations. An activation may be a data point (also referred to as “data elements” or “elements”). Activations or weights of a DNN layer may be elements of a tensor of the DNN layer. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A DNN layer may have an input tensor (also referred to as “input feature map (IFM)”) including one or more input activations (also referred to as “input elements”) and a weight tensor including one or more weights. A weight is an element in the weight tensor. A weight tensor of a convolution may be a kernel, a filter, or a group of filters. The combination of the input activation(s) and weight(s) may be referred to as input data of the DNN layer. The output data of the DNN layer may be an output tensor (also referred to as “output feature map (OFM)”) that includes one or more output activations (also referred to as “output elements”).

An input tensor may include one or more input channels. For instance, a three-dimensional input tensor may include input channels arranged along Z axis, and each input channel may include a two-dimensional matrix in the X-Y plane. For each pair of (X, Y) coordinates, the input tensor may include a sequence of data elements, each of which is in a different input channel. An output tensor may include one or more output channels. For instance, a three-dimensional output tensor may include output channels arranged along Z axis, and each output channel may include a two-dimensional matrix in the X-Y plane. For each pair of (X, Y) coordinates, the output tensor may include a sequence of data elements, each of which is in a different output channel.

Input data of a DNN layer may be sparse data, i.e., at least one element in the input tensor or weight tensor has a value of zero. For instance, some weights determined in the training phase may have values of zero. Sparse weights can cause activations to become sparse in later layers of the DNN after they go through nonlinear activation functions, such as the rectified linear activation function (ReLU). Moreover, network quantization for running inference on edge devices can also results in high number of zeros in weight and activations. Zero-valued weights and activations (collectively referred to as zero-valued input data) do not contribute towards outputs of channel-inseparable operations. A channel-inseparable operation is a deep learning operation in which a single data element in the output tensor is computed based on data elements from multiple input channels (e.g., the data elements from all the input channels of the input tensor). For instance, all the data elements having the same (X, Y) coordinates in the input tensor are used to compute a single data element in the output tensor. An example of channel-inseparable operation is standard convolution, in which partial sums for all input channels are accumulated into a single data element during MAC operations.

Sparse DNN accelerators can accelerate layers of channel-inseparable operations, which are in the backbone of many DNNs, by exploiting sparsity (i.e., presence of zero values) in the input data of these layers. Sparse DNN accelerators can achieve significant sparsity acceleration by skipping zeros in computation. In addition, these DNN accelerators can exploit the underlying data sparsity to achieve memory traffic reduction by performing zero value compression. Zero value compression prevents zero-valued input data from being stored or processed. Therefore, less amount of data is loaded from the memory and processed during computation. This in turn can result in a large amount of memory and computation energy saving and lead to significant performance improvements in the sparse DNN accelerators for layers of channel-inseparable operations.

However, most DNNs may also include other types of layers that have channel-separable operations. A channel-separable operation is a deep learning operation in which a single data element in the output tensor is computed based on one or more data elements from a subset of the input channels in the input tensor. The subset may include one or more input channels (but not all the input channels) in the input tensor. Examples of channel-separable operations include depthwise convolution, group convolution (e.g., MobileNet, DenseNet, ResNet, ResNext, etc.), elementwise addition, elementwise multiplication, channel-separable pooling operations, and so on. For channel-separable operations, zero-valued input data can contribute to the output and avoiding the zero-valued input data can impair the accuracy in the output. Thus, these layers are unable to exploit the underlying sparsity in data for acceleration and requires the input data to be stored and loaded in uncompressed format, i.e., zero-valued elements are stored and loaded.

As a result, during the execution of DNNs having channel-separable operations, the currently available DNN accelerator need to switch between compressed and uncompressed mode of storage for input data based on the type of the deep learning operation in the next layer. For DNNs that contain a lot of layers with channel-separable operations, this can have a significant detrimental impact on the overall energy consumption and lower the performance per Watt of these accelerators. In addition, the complexities around identifying which nodes need to be in compressed mode and which need to be in uncompressed mode can make it difficult to adopt sparsity acceleration.

Embodiments of the present disclosure may improve on at least some of the challenges and issues described above by dynamically uncompressing compressed sparse data for channel-separable operations in DNNs. The dynamic uncompression can facilitate sparsity-based memory and computation energy savings without impairing accuracy in outputs of channel-separable operations.

In various embodiments of the present disclosure, a DNN accelerator may include one or more compute blocks that executes various layers in DNNs. A DNN layer may have one or more deep learning operations, such as convolution, pooling, elementwise operation, linear operation, nonlinear operation, and so on. A compute block may include a memory, a datastore, a PE array, an uncompressing module, and a compressing module. The memory may store input data and output data of one or more deep learning operations executed by the compute block. The memory may be an on-chip memory, such as a SRAM (static random-access memory). The datastore may function as buffers, and input data can be loaded from memory to the datastore before they are transmitted to the PE array for computation. Output data generated by the PE array may be stored in the datastore before they are loaded to the memory.

The compute block can execute various deep learning operations including both channel-separable operations and channel-inseparable operations. For a channel-inseparable operation, the compute block can facilitate memory savings by storing compressed input data in the datastore. The compressed input data includes nonzero-valued elements and excludes zero-valued elements. The uncompressing module may dynamically uncompress the compressed input data by inserting zero values into the compressed input data and provide the uncompressed input data to the PE array for computation. For instance, the uncompressing module may determine whether an input operand includes a zero-valued data point based on a sparsity bitmap of the input operand. The sparsity bitmap includes a sequence of bits, each of which indicates whether a respective element of the input operand has a zero value or nonzero value. A bit of zero may indicate that the corresponding element has a zero value, and a bit of one may indicate that the corresponding element has a nonzero value. After determining that the input operand includes a zero-valued data point, the uncompressing module inserts the zero-valued data point into the compressed data. The uncompressing module may determine a position where to insert the zero-valued data point based on a position of the corresponding bit in the sparsity bitmap.

In some embodiments, the dynamic uncompression may include dynamic densification. The uncompressing module may change one or more bits in the sparsity bitmap of the input operand so that all the bits in the sparsity bitmap are ones. That way, all the elements in the uncompressed data, including zero-valued and nonzero-valued elements, will be treated as dense data and will be processed by the PE array.

The PE array computes an output operand based on the uncompressed data. The output operand may be stored in the datastore. In some embodiments (e.g., embodiments where the output operand include at least one zero-valued element), the compute block can further facilitate memory savings by compressing the output operand before loading it to the memory. For instance, the compressing module may generate a sparsity bitmap of the output operand and preventing the zero-valued element(s) in the output operand from being written into the memory. That way, a less amount of data is stored in the memory. The output operand may be used as input data (or a portion of input data) of another deep learning operation, such as a deep learning operation in the next layer of the DNN.

The dynamic uncompression in the present disclosure can overcome the requirements of storing zero-valued input elements in memory and loading zero-valued input elements from memory for channel-separable operations, despite the interdependence between the sparsity acceleration logic and sparse compression of data in sparse DNN accelerators. Compared with currently available DNN accelerators that typically store the input data in uncompressed format, DNN accelerators in the present disclosure can save memory storage and bandwidth and have a higher performance per Watt.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/- 20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/- 5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN

FIG. 1 illustrates an example DNN 100, in accordance with various embodiments. For purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. The layers of the DNN 100 have deep learning operations, such as convolution (e.g., standard convolution, depthwise convolution, pointwise convolution, group convolution, etc.), deconvolution, pooling operations, elementwise operations (e.g., elementwise addition, elementwise multiplication, etc.), linear operations, nonlinear operations, other types of deep learning operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as IFM 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as OFM 160). The OFM 160 is represented by a 5×5 2D matrix. The 5×5 2D matrix includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is ReLU. ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

### Example DNN Accelerator

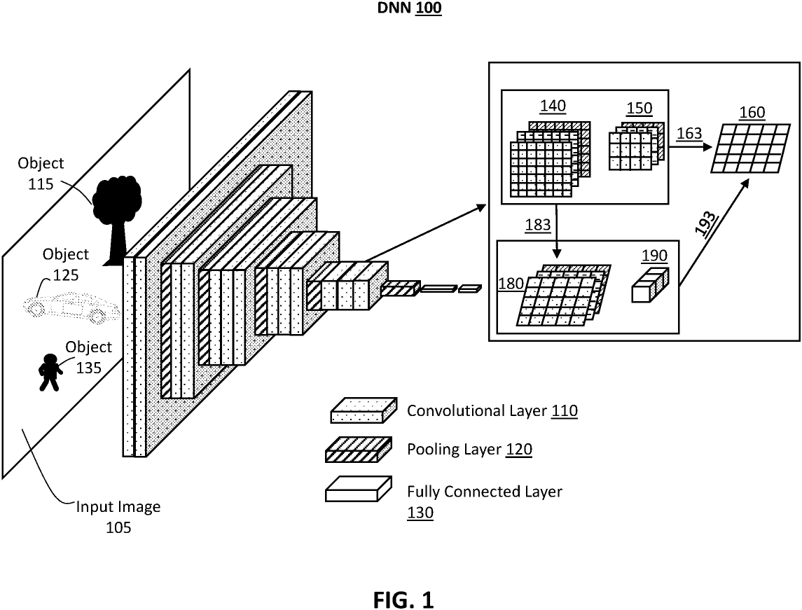

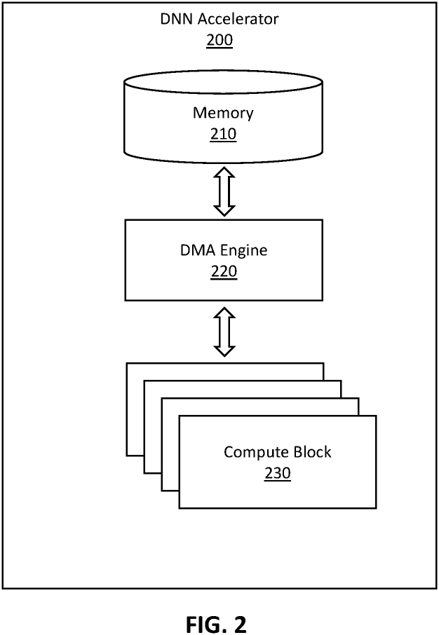

FIG. 2 is a block diagram of a DNN accelerator 200, in accordance with various embodiments. The DNN accelerator 200 can run DNNs, e.g., the DNN 100 in FIG. 1. The DNN accelerator 200 includes a memory 210, a DMA (direct memory access) engine 220, and compute blocks 230 (individually referred to as “compute block 230”). In other embodiments, alternative configurations, different or additional components may be included in the DNN accelerator 200. For example, the DNN accelerator 200 may include more than one memory 210 or more than one DMA engine 220. As another example, the DNN accelerator 200 may include a single compute block 230. Further, functionality attributed to a component of the DNN accelerator 200 may be accomplished by a different component included in the DNN accelerator 200 or by a different system.

The memory 210 stores data associated with DNNs executed by the DNN accelerator 200. The memory 210 may store data to be processed or computed by the compute blocks 230. For example, the memory 210 may store internal parameters (e.g., weights) of a DNN. As another example, the memory 210 may store input data and output data of a deep learning operation performed by one or more of the compute blocks 230. The input data may be transmitted from the memory 210 to the compute block(s) 230 through the DMA engine 220. The output data may be transmitted from the computer block(s) 230 to the memory 210 t through the DMA engine 220. In some embodiments, the memory 210 may be a main memory of the DNN accelerator 200. The memory 210 may include one or more DRAMs (dynamic random-access memory).

The DMA engine 220 facilitates data transfer between the memory 210 and local memories of the compute blocks 230. For example, the DMA engine 220 can read data from the memory 210 and write data into a local memory of a compute block 230. As another example, the DMA engine 220 can read data from a local memory of a compute block 230and write data into the memory 210. The DMA engine 220 provides a DMA feature that allows the compute block 230 to initiate data transfer between the memory 210 and the local memories of the compute blocks 230 and to perform other operations while the data transfer is in being conducted. In some embodiments, the DMA engine 220 may read tensors from the memory 210, modify the tensors in a way that is optimized for the compute block 230 before it writes the tensors into the local memories of the compute blocks 230.

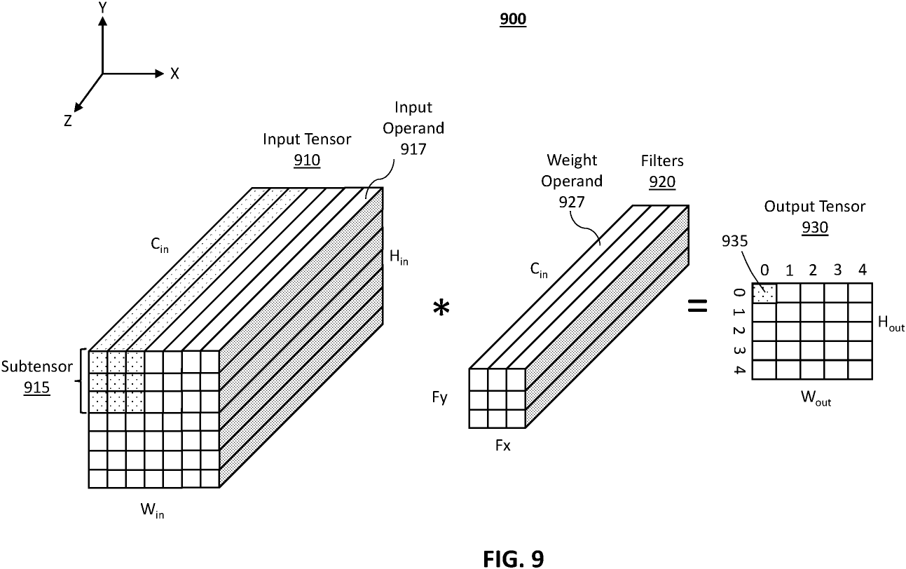

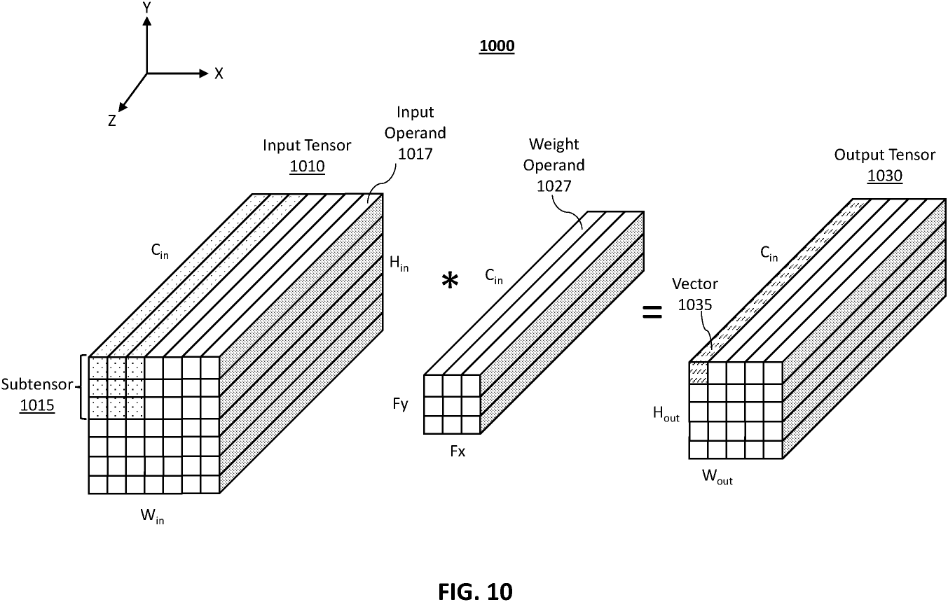

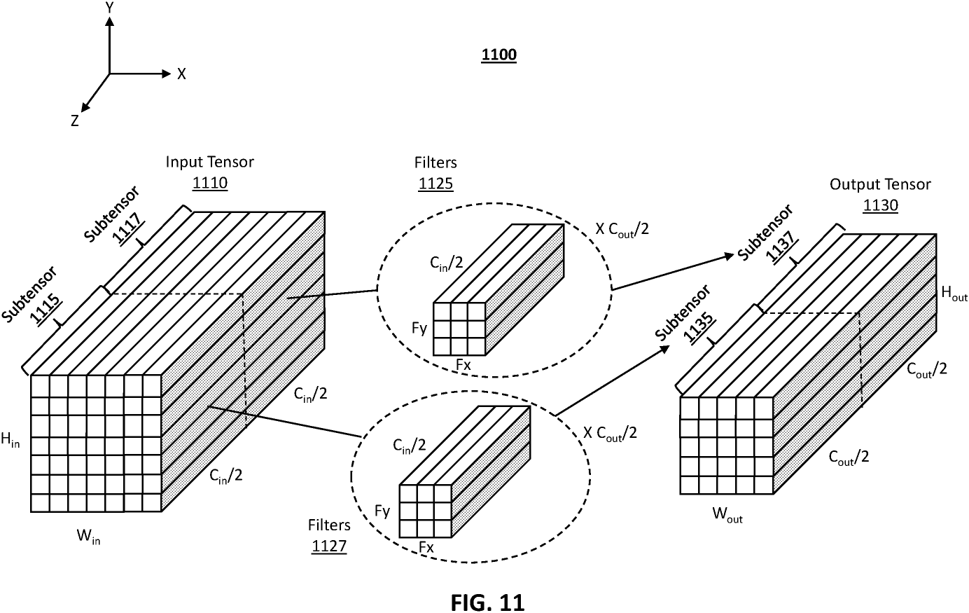

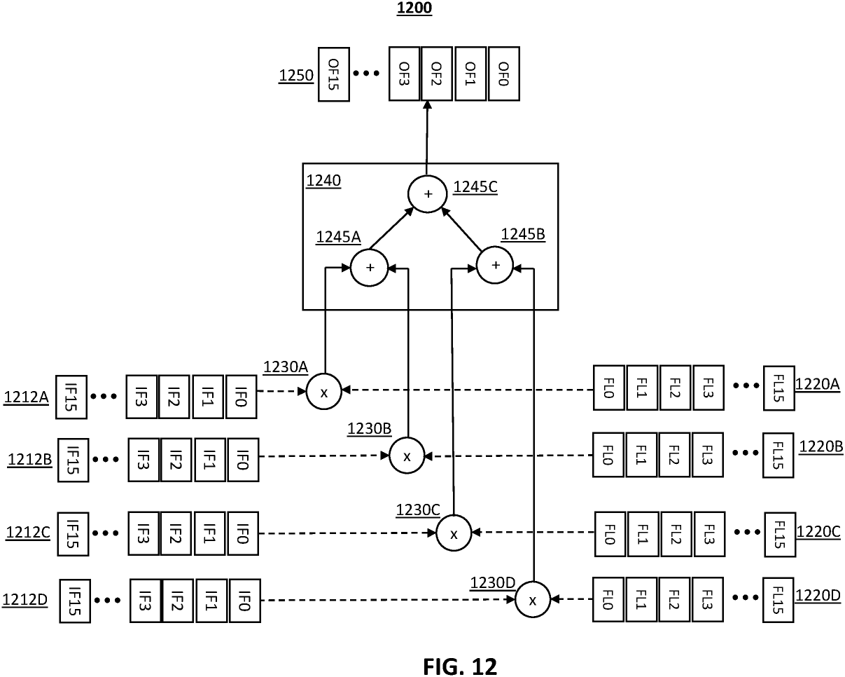

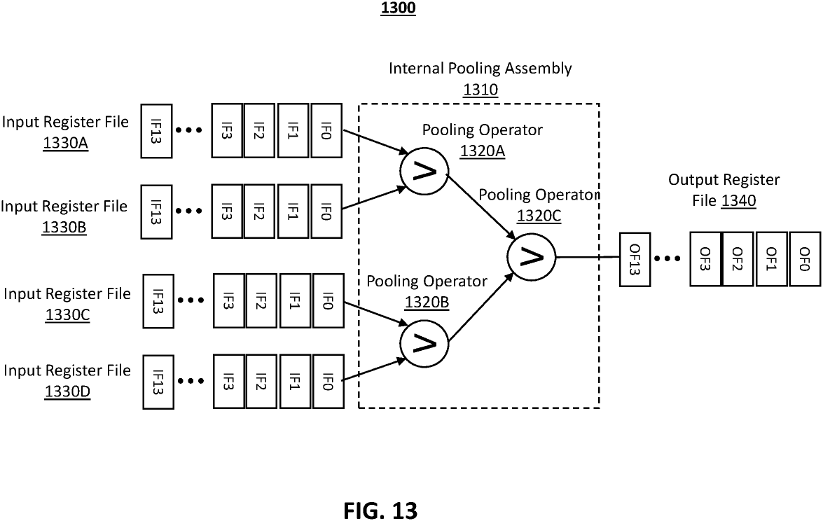

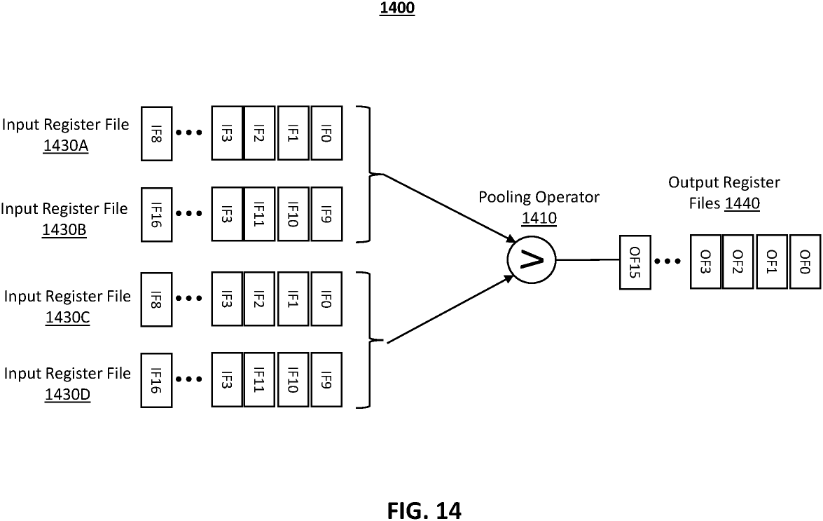

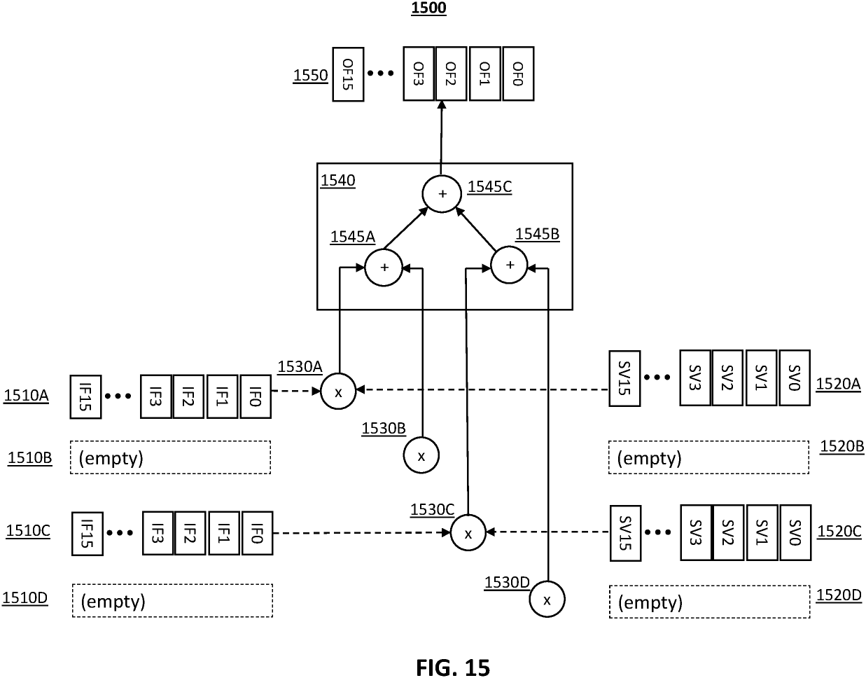

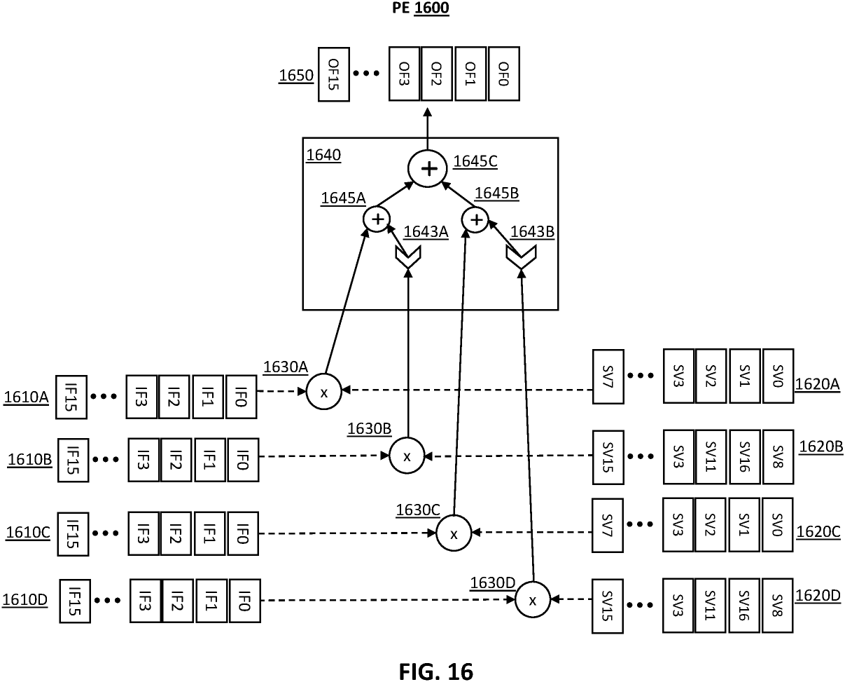

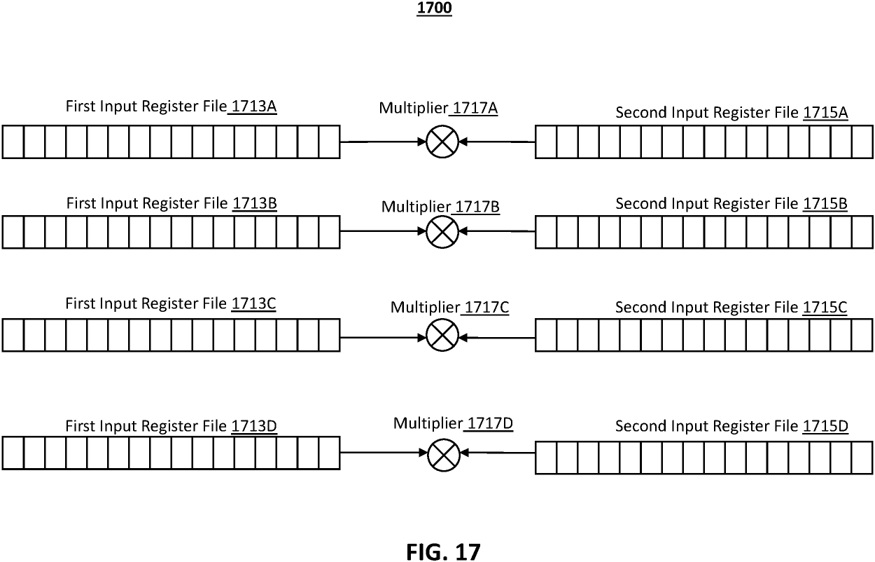

The compute blocks 230 perform computation for deep learning operations. A compute block 230 may execute a deep learning operation in a DNN layer. The deep learning operation may be a channel-inseparable operation or a channel-separable operation. Examples of the deep learning operation may include standard convolution (e.g., the standard convolution 163 in FIG. 1, the standard convolution 900 in FIG. 9, etc.), depthwise convolution (e.g., the depthwise convolution 183 in FIG. 1, the depthwise convolution 1000 in FIG. 10, the depth convolution in FIG. 12, etc.), pointwise convolution (e.g., the pointwise convolution 193 in FIG. 1, etc.), group convolution (e.g., the group convolution 1100 in FIG. 11, etc.), deconvolution, pooling operations (e.g., the channel-separable pooling operations in FIGS. 13 and 14, etc.), elementwise operations (e.g., the elementwise additions in FIGS. 15 and 16, the elementwise multiplication in FIG. 17, etc.), linear operations, nonlinear operations, other types of deep learning operations, or some combination thereof.

In some embodiments, multiple compute blocks 230 may run in parallel to execute a deep learning operation. For instance, each of the compute blocks 230 may process a different portion of the input data of the deep learning operation and generate a different portion of the output data of the deep learning operation. In some embodiments, an output of a deep learning operation executed by a compute block 230 may be used as an input of another deep learning operation to be executed by the same compute block 230 or one or more other compute blocks 230.

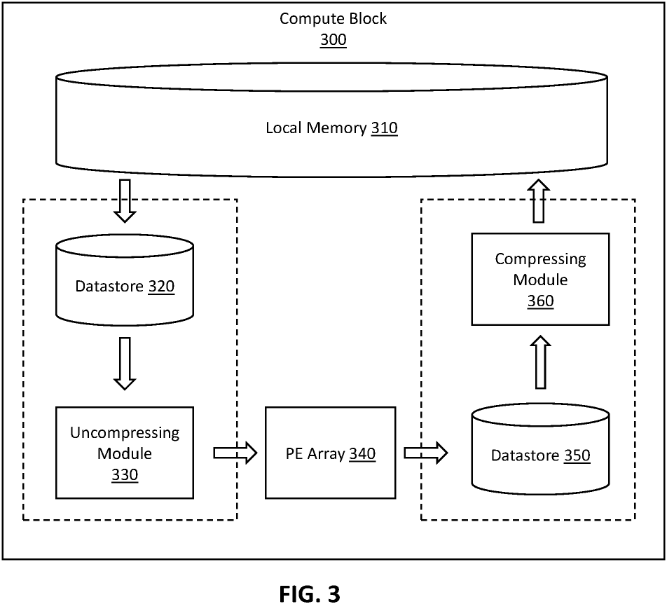

The compute blocks 230 may execute both channel-inseparable operations and channel-separable operations. A compute block 230 may be implemented with dynamic uncompression, with which the compute block 230 can store compressed data in its local memory and load compressed data from the local memory to buffers, despite whether the deep learning operation is channel inseparable or channel inseparable. The compressed data may be generated by removing zero values from input data or output data of the deep learning operation. Certain aspects of the compute blocks 230 are described below in conjunction with FIG. 3.

FIG. 3 is a block diagram of a compute block 300, in accordance with various embodiments. The compute block 300 may be an example of a compute block 230 in FIG. 2. As shown in FIG. 3, the compute block 300 includes a local memory 310, datastores 320 and 350, an uncompressing module 330, a PE array 340, and a compressing module 360. In other embodiments, alternative configurations, different or additional components may be included in the compute block 300. For example, the datastores 320 and 350 may be implemented as a single datastore. As another example, the compute block 300 may include more than one local memory 310, PE array 340, uncompressing module 330, or compressing module 360. Further, functionality attributed to a component of the compute block 300 may be accomplished by a different component included in the compute block 300, another component of the DNN accelerator 200, or by a different system.

The local memory 310 is local to the compute block 300. In the embodiments of FIG. 3, the local memory 310 is inside the compute block 300. In other embodiments, the local memory 310 may be outside the compute block 300. The local memory 310 and the compute block 300 can be implemented on the same chip. In some embodiments, the local memory 310 includes one or more SRAMs. The local memory 310 may be byte-addressable, and each memory address identifies a single byte (eight bits) of storage. In some embodiments, the local memory 310 may include banks, each bank may have a capacity of a fixed number of bytes, such as 22, 64, and so on.

The local memory 310 may store input data (e.g., input tensors, filters, etc.) and output data (e.g., output tensors, etc.) of deep learning operations run by the compute block 300. A tensor may include elements arranged in a vector, a 2D matrix, or a 3D matrix. In embodiments where a tensor is a 3D matrix, the position of an element in the tensor may be represented by (X, Y, Z) coordinates. The Z axis of the 3D matrix may correspond to channels of the DNN layer, and the Z coordinate of an element may indicate which channel the element is located. Data stored in the local memory 310 may be in compressed format. For instance, for a tensor including one or more nonzero-valued elements and one or more zero-valued elements, the local memory 310 may store the one or more nonzero-valued elements and not store the one or more zero-valued elements. The local memory 310 may also store other data associated with deep learning operations run by the compute block 300, such as sparsity bitmaps that can be used to accelerate deep learning operations.

A sparsity bitmap may be associated with an operand of a deep learning operation. An operand may be at least a portion of a tensor of a DNN layer. In some embodiments, the elements in an operand may have the same Z coordinate, i.e., the elements are in the same channel. Taking a convolutional layer for example, an input operand may include one or more input activations in the input tensor of the convolution, a weight operand may include one or more weights in the filter(s) of the convolution, and an output operand may include one or more output activations in the output tensor of the convolution. An input operand or weight operand may be processed by the PE array 340 (e.g., one or more PEs in the PE array 340) to compute an output operand. A sparsity bitmap of an operand may include one or more bits, each of which corresponds to a respective element in the operand and indicates whether the respective element is zero-valued or nonzero-valued. In an example, a bit of zero indicates that the corresponding element is zero-valued, versus a bit of one indicates that the corresponding element is nonzero-valued.

The datastore 320 stores data to be used by the PE array 340 for executing deep learning operations. The datastore 320 may function as one or more buffers between the local memory 310 and the PE array 340. Data in the datastore 320 may be loaded from the local memory 310 and can be transmitted to the PE array 340 for computations. In some embodiments, the datastore 320 includes one or more databanks. A databank may include a sequence of storage units. A storage unit may store a portion of the data in the databank. In some embodiments, the storage units may have a fixed storage size, e.g., 32, 64, 126 bytes. The number of storage units in the datastore 320 may be 8, 16, 32, 64, and so on.

A storage unit may be a buffer for a PE at a time. Data in a storage unit may be fed into one or more PEs for a computation cycle of the PEs. For different computation cycles, the storage unit may be the buffer of different PEs. Data in a storage unit may be fed to the PE array 340 through a MAC lane. A MAC lane is a path for loading data into the PE array 340 or a portion of the PE array 340, such as a PE column in the PE array 340. A MAC lane may be also referred to as a data transmission lane or data load lane. The PE array 340 (or a PE column) may have multiple MAC lanes. The loading bandwidth of the PE array 340 (or a PE column) is an aggregation of the loading bandwidths of all the MAC lanes associated with the PE array 340 (or the PE column). In an example where the PE array 340 (or a PE column in the PE array 340) has four MAC lanes and each MAC lane may have a bandwidth of 16 bytes, the four MAC lanes can have a total loading bandwidth of 64 bytes. With N MAC lanes (where N is an integer), data may be fed into N PEs simultaneously. In some embodiments (e.g., embodiments where every PE column has a separate MAC lane), the data in a storage unit may be broadcasted to multiple PE columns through the MAC lanes of these PE columns. In an embodiment where every PE column has more than one separate MAC lane, data in more than one storage unit can be broadcasted to multiple PE columns. In an example where each PE column has four MAC lanes, data in four storage units can be broadcasted to multiple PE columns.

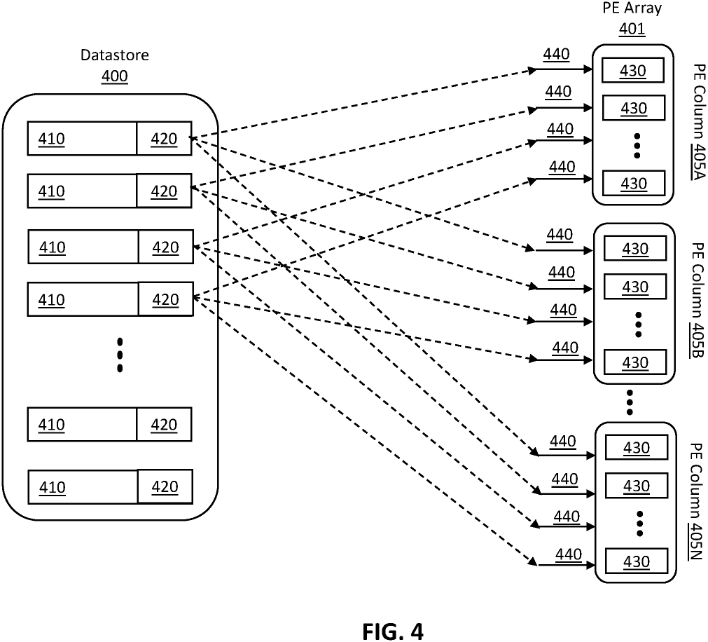

In some embodiments, the datastore 320 may store at least a portion of an input tensor or at least a portion of a weight tensor of a DNN layer. A storage unit may store at least a portion of an operand (e.g., an input operand or a weight operand). The storage unit may also store the sparsity bitmap of the operand. In some embodiments (e.g., embodiments where the local memory 310 stores input data in compressed format), the input data in the datastore 320 is in compressed format. For instance, the datastore 320 stores nonzero-valued activations or weights, but zero-valued activations or weights are not stored in the datastore 320. The compressed data in the datastore 320 may be uncompressed by the uncompressing module 330 before being fed into the PE array 340. Certain aspects of the datastore 320 are described below in conjunction with FIG. 4.

The uncompressing module 330 uncompresses data from the datastore 320. In some embodiments, the uncompressing module 330 may receive compressed data from the datastore 320, e.g., from a storage unit of the datastore 320. The compressed data may be one or more nonzero-valued elements in an operand (e.g., an input operand or a weight operand) of a deep learning operation. In embodiments where the operand includes one or more zero-valued elements, the compressed data does not include the zero-valued elements. The uncompressing module 330 may also receive a sparsity bitmap of the operand from the datastore 320.

In some embodiments, the uncompressing module 330 determines whether an operand includes zero-valued elements that are not stored in the datastore 320 based on the sparsity bitmap of the operand. The uncompressing module 330 may determine whether there are any zeros in the sparsity bitmap. In response to determining that there is a zero-valued bit in the sparsity bitmap, the uncompressing module 330 determines that there is a zero-valued element in the operand. The uncompressing module 330 may determine that the operand includes one or more zero-valued elements. After such a determination, the uncompressing module 330 may insert the one or more zero-valued elements into the compressed data, resulting in uncompressed data. The uncompressed data may include all the elements in the operand, including both zero-valued element(s) and nonzero-valued element(s).

In some embodiments, the elements in the operand may be arranged in a sequence, e.g., the sequence of the channels in the tensor. The bits in the sparsity map may also be in a sequence. The position of a bit in the sparsity map may match (e.g., be the same as) the position of the corresponding element in the operand. The uncompression module 330 may determine a position where to insert a zero-valued element into the compressed data based on a position of the corresponding bit in the sparsity bitmap. The corresponding bit is the zero-valued bit based on which the uncompression module 330 determined that the operand include the zero-valued element. A position of the zero-valued element in the uncompressed data (or in the operand) may be the same as the position of the corresponding bit in the sparsity bitmap.

Even though not shown in FIG. 3, the uncompressing module 330 may include or otherwise be associated with one or more sparsity accelerators. A sparsity accelerator can accelerate computations (e.g., computations for a channel-inseparable operation) in the PE array 340 based on sparsity in the input data. In some embodiments, a sparsity accelerator can accelerate computations in a single PE. In other embodiments, a sparsity accelerator can accelerate computations in multiple PEs, such as one or more PE columns or the entire PE array 340.

In some embodiments (e.g., embodiments where the compute block 300 executes a convolutional layer), the uncompressing module 330 may generate an input operand and a weight operand by uncompressing data from the datastore 320. The input operand may be a portion of the input tensor of the convolution. The input operand includes a sequence of input elements. The activations may be from different input channels. For instance, each activation is from a different input channel from all the other activations in the input operand. The input operand is associated with an input bitmap, which may be received by the uncompressing module 330 from the datastore 320. The input bitmap can indicate positions of the nonzero-valued activations in the input operand. The input bitmap may include a sequence of bits, each of which corresponds to a respective activation in the input operand. The position of a bit in the input bitmap may match the position of the corresponding activation in the input operand. A bit in the input bitmap may be zero or one. A zero-valued bit indicates that the value of the corresponding activation is zero, a one valued bit indicates that the value of the corresponding activation is nonzero. In some embodiments, the input bitmap may be generated during the execution of another DNN layer, e.g., a layer that is arranged before the convolutional layer in the DNN.

The weight operand may be a portion of a kernel of the convolution. The weight operand includes a sequence of weights. The values of the weights are determined through training the DNN. The weights in the weight operand may be from different input channels. For instance, each weight is from a different input channel from all the other weights in the weight operand. The weight operand is associated with a weight bitmap, which may be received by the uncompressing module 330 from the datastore 320. The weight bitmap can indicate positions of the nonzero-valued weights in the weight operand. The weight bitmap may include a sequence of bits, each of which corresponds to a respective weight in the weight operand. The position of a bit in the weight bitmap may match the position of the corresponding weight in the weight operand. A bit in the weight bitmap may be zero or one. A zero-valued bit indicates that the value of the corresponding weight is zero, a one valued bit indicates that the value of the corresponding weight is nonzero.

The sparsity accelerator may generate a combined bitmap for the MAC operation based on the input bitmap and the weight bitmap. In some embodiments, the sparsity accelerator generates the combined sparsity bitmap by performing one or more AND operations on the input bitmap and the weight bitmap. Each bit in the combined sparsity bitmap is a result of an AND operation on a bit in the input bitmap and a bit in the weight bitmap, i.e., a product of the bit in the input bitmap and the bit in the weight bitmap. The position of the bit in the combined sparsity bitmap matches (e.g., is the same as) the position of the bit in the input bitmap and the position of the bit in the weight bitmap. A bit in the combine bitmap corresponds to a pair of activation and weight (activation-weight pair). A zero bit in the combined bitmap indicates that at least one of the activation and weight in the pair is zero. A one bit in the combined bitmap indicates that both the activation and weight in the pair are nonzero.

The sparsity accelerator may provide activation-weight pairs to the PE based on the combined bitmap. For instance, the sparsity accelerator may identify activation-weight pairs corresponding to the ones in the combined bitmap and forward these activation-weight pairs to the PE. The sparsity accelerator may skip the other activation-weight pairs, as they will not contribute to the result of the MAC operation in a channel-inseparable convolution (e.g., standard convolution). The total number of ones in the combined bitmap may equal the total number of activation-weight pairs that will be computed by the PE. By skipping the activation-weight pairs corresponding to zero bits in the combined bitmap, the computation of the PE will be faster, compared with the PE computing all the activation-weight pairs in the input operand and weight operand.

However, such sparsity acceleration may not apply in channel-separable convolutions (e.g., depthwise convolution, group convolution, etc.) as activation-weight pairs corresponding to zeros in the combined bitmap can contribute to the result of the MAC operation and skipping these activation-weight pairs can impair the accuracy in the result. To avoid the risk for channel-separable operations, the uncompressing module 330 may update the sparsity bitmap of an operand. The updated sparsity bitmap may include ones and not include any zeros. In embodiments where the operand is an input operand or a weight operand, the uncompressing module 330 may update the input sparsity bitmap, the weight sparsity bitmap, the combined sparsity bitmap, or some combination thereof. By updating the sparsity bitmap, the uncompressing module 330 can densify the zero-valued element(s), e.g., by changing the corresponding bit(s) in the sparsity bitmap from zero(s) to one(s) so that the sparsity accelerator(s) will not prevent the zero-valued element(s) from being sent to the PE array 340.

In some embodiments, the uncompressing module 330 may have an uncompressing mode and a bypass mode. In the uncompressing mode, the uncompressing module 330 may uncompress data from the datastore 320 and sends uncompressed data to the PE array 340. In the bypass mode, the uncompressing module 330 may send data from the datastore 320 to the PE array 340 without any uncompression so that the PE array 340 receives compressed data. The uncompressing module 330 may be set to the uncompressing mode, e.g., in embodiments where the compute block 300 executes a channel-inseparable operation. The uncompressing module 330 may be set to the bypass mode, e.g., in embodiments where the compute block 300 executes a channel-separable operation.

The uncompressing module 330 may be implemented at the datastore 320. For example, the uncompression module 330 may be implemented at a storage unit of the datastore 320 and uncompresses data in the storage unit before the data is fed into the PE array 340. Even though FIG. 3 shows one uncompressing module 330, the compute block 300 may include more than one uncompressing module 330. For instance, the compute block 300 may include a separate uncompressing module 330 for every storage unit in the datastore 320. The uncompression by the uncompressing module 330 can be dynamic. For instance, the uncompression is performed as data is being loaded from the datastore 320 to the PE array 340. With such dynamic uncompression, the zero-valued elements in the uncompressed data are not stored in the datastore 320. Rather, the zero-valued elements, after they are generated by the uncompressing module 330, can be directly provided to the PE array 340. Thus, the uncompression does not impair the memory savings at datastore 320 or the local memory 310.

The PE array 340 performs computations to execute deep learning operations, including channel-separable operations and channel-inseparable operations. The PE array 340 may include PEs arranged in columns, or columns and rows. In some embodiments, a PE includes one or more multipliers for performing multiplications. An PE may also include one or more adders for performing accumulations. A column of PEs is referred to as a PE column. As described above, a PE column may be associated with one or more MAC lanes for receiving data from the datastore 320. In some embodiments, a PE may perform multiple rounds of computations (e.g., MAC operations) for a deep learning operation. Data (activations, weights, or both) may be reused within a single round, e.g., across different multipliers in the PE, or reused across different rounds of MAC operations. Certain aspects of components in the PE array 340 or in a PE are described below in conjunction with FIGS. 12-19.

The PE array 340 generates output data through computations in the PE array 340. The output data may be at least a portion of an output tensor of a deep learning operation in a DNN layer. The output data may be input data of. The output data may include one or more output operands. In some embodiments, the output may be sparse data in uncompressed format and include one or more zero-valued elements. A sparsity bitmap for an output operand may also be stored in the datastore 350. In some embodiments, the sparsity bitmap may be generated by the uncompressing module 330 or a sparsity accelerator, e.g., before the output operand is computed. In other embodiments, the sparsity bitmap may be generated by the compressing module 360 after the output operand is computed.

The compressing module 360 compresses output data in the datastore 350. In some embodiments, the compressing module 360 removes zero values from the output data to generate compressed data. The compressing module 360 may also generate one or more sparsity bitmaps for the output data. A sparsity bitmap may include a sequence of bits, each of which indicates whether a respective element in an output operand is a zero value or not. The compressed data and sparsity bitmap(s) may be written into the local memory 310. In some embodiments, the compressed data and sparsity bitmap(s) may be used to execute another deep learning operation, e.g., a deep learning operation in the next DNN layer, in which the compressed data may be used as input data.

### Example Dynamic Uncompression

FIG. 4 illustrates a datastore 400 implemented with uncompressing modules 420, in accordance with various embodiments. The uncompressing modules 420 are individually referred to as uncompressing module 420. An uncompressing module 420 may be an embodiment of the uncompression module 330 in FIG. 3. The datastore 400 may be an embodiment of the datastore 320 in FIG. 3. The datastore 400 includes a plurality of storage units 410 (individually referred to as “storage unit 410”). Each storage unit 410 is coupled with an uncompressing module 420. The uncompressing module 420 may be located at the storage unit 410 or be arranged adjacent to the storage unit 410. In other embodiments, multiple storage unit 410 may share one uncompressing module 420. FIG. 4 also shows a PE array 401 that includes PE columns 405A-405N (collectively referred to as “PE columns 405” or “PE column 405”). Each PE column 405 includes a plurality of PEs 430 (individually referred to as “PE 430”) and has four data transfer lanes 440 (individually referred to as “data transfer lane 440”). In other embodiments, the PE array 401 may include a different number of PE columns 405, or a PE column may have a different number of data transfer lanes 440. The PE array 401 may be an embodiment of the PE array 401 340 in FIG. 3.

In some embodiments, the storage units 410 may be loaded with compressed data and sparsity bitmaps from a memory, such as the local memory 310. The compressed data includes nonzero-valued elements of an operand and does not include any zero-valued elements. In an example, a storage unit 410 may store the compressed data of one operand and the sparsity bitmap of the operand at a time. After the compressed data and sparsity bitmap are fetched into the PE array 401, the storage unit 410 may store the compressed data of a new operand and the sparsity bitmap for the new operand. The storage unit 410 may have a storage capacity that is no less than the storage size of the operand plus the storage size of the sparsity bitmap. The operand may have a predetermined storage size, e.g., a predetermined number of bytes. The sparsity bitmap may have a predetermined storage size, e.g., a predetermined number of bits. The predetermined number of bytes or bits in the operand or the sparsity bitmap may be, for example, 8, 16, 32, 64, 128, and so on.

The compressed data in the datastore 400 is distributed to the PE array 401 for computations in the PEs 430. In the data distribution process, the uncompressing module 420 of a storage unit 410 can form the operand based on the compressed data and sparsity bitmap from the storage unit 410. For instance, the uncompressing module 420 inserts one or more zero-valued elements into the compressed data, e.g., after it identifies one or more zeros in the sparsity bitmap. After the insertion, the operand is regenerated and includes the one or more zero-valued elements and all the nonzero-valued element(s) stored in the storage unit 410. The total number of elements in the operand may equal the number of bits in the sparsity bitmap. In some embodiments (e.g., embodiments where a sparsity accelerator is available to accelerate PE computations), the uncompressing module 420 may also set all the bits in the sparsity bitmap so that all the bits will be ones. That way, all the elements in the operand will be considered as dense data by the sparsity accelerator and will be fetched into the PE column. The elements in the operand may correspond to different channels in a tensor of the DNN layer to be executed by the PE array 401. For instance, all the elements may have the same (X, Y) coordinates but different Z coordinates.

In some embodiments (e.g., embodiment where the PE array 401 runs a channel-inseparable operation), the uncompressing module 420 of a storage unit may be disabled. For instance, the uncompressing module 420 may operate in a bypass mode. When the uncompressing module 420 is disabled, the uncompressing module 420 will not uncompress the compressed data or change the sparsity bitmap from the storage unit 410. The compressed data will be provided to the PE array 401, and the PE array 401 will process the nonzero-valued elements in the compressed data, while the zero-valued elements in the operand will be skipped.

Data (e.g., uncompressed data in embodiments where the uncompressing modules 420 are enabled or compressed data in embodiments where the uncompressing modules 420 are disabled) are fetched into the PE array 401 through the data transfer lanes 440. For the purpose of illustration, each PE column 405 has four data transfer lanes 440 and can receive data from four storage units 410 in one cycle. As shown in FIG. 4, each data transfer lane 440 can facilitate transfer of data from a different storage unit 410. Also, the data in the same four storage units 410 can be broadcasted to some or all of the PE columns 405 in one cycle. FIG. 4 shows that the data in the top four storage units 410 are fetched into all the PE columns 405 simultaneously. The data can therefore be reused by all the PE columns 405, which can improve efficiency of the datastore 400.

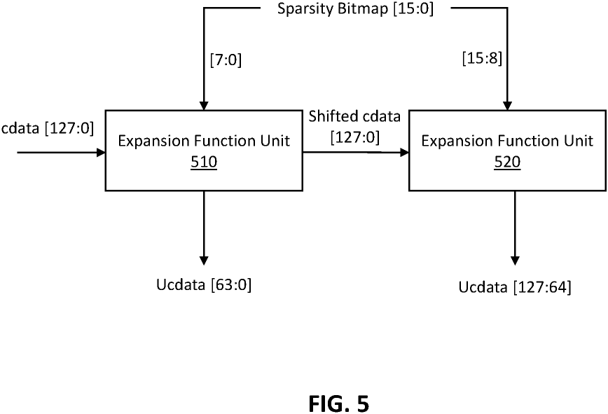

FIG. 5 illustrates a dynamic uncompressing process in an uncompressing module comprising two expansion function units 510 and 520, in accordance with various embodiments. Even though not shown in FIG. 5, the uncompressing module may include other components. Also, the uncompressing module may include one or more than two expansion function units. The uncompressing module in FIG. 5 may be an embodiment of the uncompressing module 330 in FIG. 3 or an uncompressing module 420 in FIG. 4.

The expansion function units 510 and 520 receives a compressed data stream, which is represented as cdata in FIG. 5. The compressed data stream includes nonzero-valued elements of an operand, e.g., an input operand or weight operand. The compressed data stream may be formed by removing zero-valued elements from the operand. The expansion function units 510 and 520 expands the compressed data stream by inserting the nonzero-valued elements into compressed data stream to regenerate the operand based on the sparsity bitmap of the operand.

In the embodiments of FIG. 5, the compressed data stream has a storage size limit of 128 bits (i.e., 16 bytes), which is represented by [127:0] in FIG. 5. The data in the compressed data stream may be less than 16 bytes. The compressed data stream includes nonzero-valued elements of an operand. The sparsity bitmap includes 16 bits, which is represented by [15:0] in FIG. 5. The sparsity bitmap is divided into two bit streams: the first bit stream includes the first 8 bits in the sparsity bitmap (i.e., [7:0]) and the second bit stream includes the other 8 bits in the sparsity bitmap (i.e., [15:8]). Similarly, the compressed data stream is divided into two data streams: the first data stream includes the first 64 bits (i.e., [63:0]) and the second data stream includes the other 64 bits (i.e., [127:64]). The expansion function unit 510 expands the first data stream based on the first bit stream and outputs a first uncompressed data stream including 64 bits, which is represented by ucdata [63:0] in FIG. 15. The expansion function unit 520 expands the second data stream based on the second bit stream and outputs a second uncompressed data stream including 64 bits, which is represented by ucdata [127:64] in FIG. 15. The first uncompressed data stream and the second uncompressed data stream constitute an uncompressed data stream, which may include all the elements of the operand, including zero-valued and nonzero-valued elements.

The expansion function unit 510 may also set all the bits in the first bit steam, e.g., by changing zeros in the first bit stream to ones. Similarly, the expansion function unit 520 may also set all the bits in the second bit steam, e.g., by changing zeros in the second bit stream to ones. The uncompressing module can output a new sparsity bitmap that includes 16 ones.

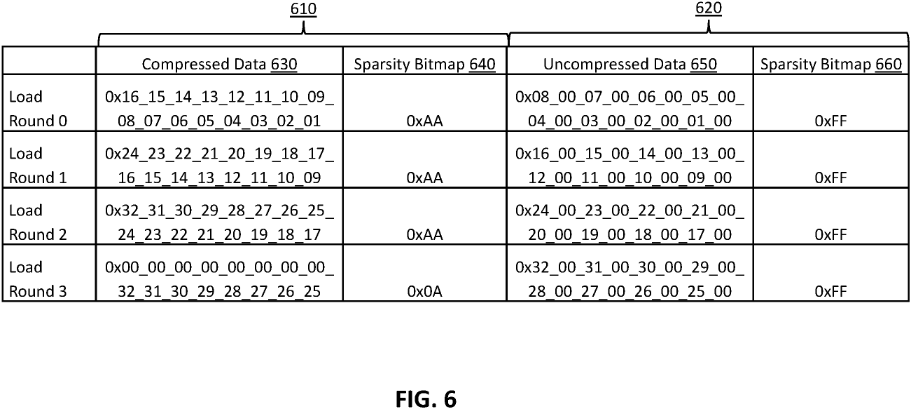

FIG. 6 illustrates input 610 and output 620 of an uncompressing module for four load rounds, in accordance with various embodiments. The uncompressing module in FIG. 6 may be an embodiment of the uncompressing module 330 in FIG. 3, an embodiment of an uncompressing module 420 in FIG. 4, or an embodiment of the uncompressing module in FIG. 5.

The input 610 includes compressed data 630 and a sparsity bitmap 640. The output includes uncompressed data 650 and a sparsity bitmap 660. The uncompressed data 650 may be generated by the uncompressing module by inserting zeros into the compressed data 630 based on the zeros in the sparsity bitmap 640. The sparsity bitmap 660 may be generated by the uncompressing module by setting all the bits in the sparsity bitmap 640. The uncompressed data 650 may be loaded into one or more PEs, which will execute a deep learning operation using the uncompressed data 650 as input data.

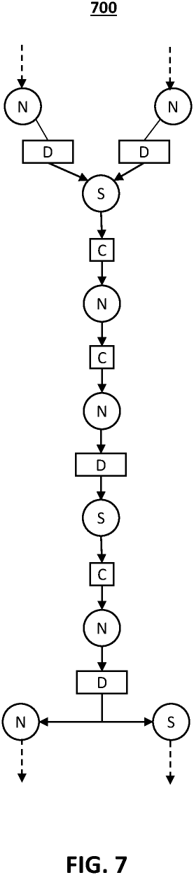

FIG. 7 illustrates a DNN 700 executed without dynamic uncompression in accordance with various embodiments. An embodiment of the DNN 700 may be the DNN 100 in FIG. 1. The DNN 700 includes a plurality of layers with channel-inseparable operations, which are represented by circles with N in FIG. 7. The DNN 700 also includes a plurality of layers with channel-separable operations, which are represented by circles with S in FIG. 7. FIG. 7 also shows data transferred between the layers. A rectangular with C represents a compressed data stream that does not include zero-valued elements. A rectangular with D represents a uncompressed data stream that includes zero-valued elements.

As shown in FIG. 7, the data streams to be transferred to layers with channel-inseparable operations are in compressed format. However, the data streams to be transferred to layers with channel-separable operations are in uncompressed format. Compared with the compressed data, the uncompressed data requires more storage in memory. Also, the transfer of the uncompressed data consumes more bandwidth.

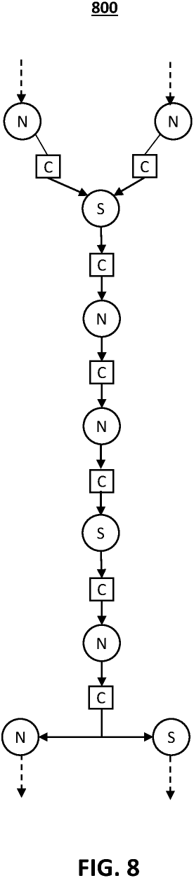

FIG. 8 illustrates a DNN 800 executed with dynamic uncompression, in accordance with various embodiments. An embodiment of the DNN 800 may be the DNN 100 in FIG. 1. The DNN 800 includes a plurality of layers with channel-inseparable operations, which are represented by circles with N in FIG. 8. The DNN 800 also includes a plurality of layers with channel-separable operations, which are represented by circles with S in FIG. 8. The layers in the DNN 800 are the same as the layers in the DNN 700. FIG. 8 also shows data transferred between the layers. A rectangular with C represents a compressed data stream that does not include zero-valued elements.

As shown in FIG. 8, the data streams to be transferred to all the layers in the DNN 800 are in compressed format. Even though the DNN 800 includes the same layers as the DNN 700, the dynamic uncompression allows compressed data streams to be transferred to layers with channel-separable operations. Different from the embodiments of FIG. 7 in which uncompressed data streams are stored and loaded from memory, no uncompressed data streams are stored or loaded from memory in the embodiment of FIG. 8. Rather, compressed data streams can be stored and loaded from memory and then be dynamically converted to uncompressed data streams as the compressed data streams are fetched from buffers to PEs. Therefore, the dynamic uncompression can save memory and bandwidth consumptions.

### Example Channel-Inseparable Operation

FIG. 9 illustrates an example standard convolution 900, in accordance with various embodiments. The standard convolution 900 may be a convolution in a convolutional layer of a DNN, e.g., a convolutional layer 110 in FIG. 1. The standard convolution 900 may be an example of the standard convolution 163 in FIG. 1. The standard convolution 900 is executed on input data including an input tensor 910 and a filter 920. A result of the standard convolution 900 is an output tensor 930. In some embodiments, the standard convolution 900 is performed by a DNN accelerator including one or more compute block. An example of the DNN accelerator may be the DNN accelerator 200 in FIG. 2. An example of the compute blocks may be the compute block 300 in FIG. 3.

In the embodiments of FIG. 9, the input tensor 910 includes activations (also referred to as “input activations,” “elements,” or “input elements”) arranged in a 3D matrix. An activation in the input tensor 910 is a data point in the input tensor 910. The input tensor 910 has a spatial size Hᵢₙ × Wᵢₙ × Cᵢₙ, where Hᵢₙ is the height of the 3D matrix (i.e., the length along the Y axis, which indicates the number of activations in a column in the 2D matrix of each input channel), Wᵢₙ is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). For purpose of simplicity and illustration, Hᵢₙ and Wᵢₙ are both 7, i.e., the input tensor 910 includes a 7×7 2D matrix for each input channel. Each input element in the input tensor 910 may be represented by a (X, Y, Z) coordinate. In other embodiments, the height, width, or depth of the input tensor 910 may be different.

The filter 920 includes weights arranged in a 3D matrix. The values of the weights may be determined through training the DNN. A filter 920 has a spatial size H_{f} × W_{f} × Cᵢₙ, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and Cᵢₙ is the depth of the filter (i.e., the length along the Z axis, which indicates the number of input channels). For purpose of simplicity and illustration, the filter 920 has a 3×3 kernel for each input channel. In other embodiments, the height, width, or depth of the filter 920 may be different. The spatial size of the convolutional kernels is smaller than the spatial size of the 2D matrix of each input channel in the input tensor 910.

An activation or weight may take one or more bytes in a memory. The number of bytes for an activation or weight may depend on the data format. For example, when the activation or weight has an integral format (e.g., INT8), the activation takes one byte. When the activation or weight has a floating-point format (e.g., FP16 or BF16), the activation or weight takes two bytes. Other data formats may be used for activations or weights.

In the standard convolution 900, the filter 920 slides across the input tensor 910 and generates a 2D matrix, i.e., the output tensor 930. In the embodiments of FIG. 9, the output tensor 930 has a spatial size of 5×5. The output tensor 930 has a single output channel. This is because the standard convolution 900 is channel-inseparable operation, in which the input channels are combined into one output channel and are not separated anymore.

As a part of the standard convolution 900, MAC operations can be performed on a 3×3×3 subtensor 915 (which is highlighted with dot patterns in FIG. 9) in the input tensor 910 and the filter 920. The subtensor 915 and the filter 920 have the same spatial size. The result of the MAC operations on the subtensor 915 and one filter 920 is an output activation 935, which is highlighted with dot patterns in FIG. 9. In some embodiments (e.g., embodiments where the convolution is an integral convolution), the output activation 935 may include 8 bits, e.g., one byte. In other embodiments (e.g., embodiments where the convolution is a floating-point convolution), the output activation 935 may include more than one byte. For instance, the output activation 935 may include two bytes.

After the output activation 935 is produced, further MAC operations are performed to produce additional output activations till the entire output tensor 930 is produced. For instance, the filter 920 may move over the input tensor 910 along the X axis or the Y axis, and MAC operations can be performed on the filter 920 and another subtensor in the input tensor 910 (the subtensor has the same size as the filter 920). The amount of movement of a filter 920 over the input tensor 910 during different compute rounds of the convolution is referred to as the stride size of the convolution. The stride size may be 1 (i.e., the amount of movement of the filter 920 is one activation), 2 (i.e., the amount of movement of the filter 920 is two activations), and so on. The height and width of the output tensor 930 may be determined based on the stride size.

In some embodiments, the MAC operations on a 3×3×3 subtensor (e.g., the subtensor 915) and a filter 920 may be performed by a plurality of PEs, such as PEs in the PE array 340. One or more PEs may receive an input operand (e.g., an input operand 917 shown in FIG. 9) and a weight operand (e.g., the weight operand 927 shown in FIG. 9). The input operand 917 includes a sequence of activations having the same (X, Y) coordinate but different Z coordinates. Similarly, the weight operand 927 includes a sequence of weights having the same (X, Y) coordinate but different Z coordinates. The length of the input operand 917 may be the same as the length of the weight operand 927. Activations in the input operand 917 and weights in the weight operand 927 may be sequentially fed into a PE. The PE may receive an activation-weight pair of at a time and multiple the activation and the weight. The position of the activation in the input operand 917 may match the position of the weight in the weight operand 927.

The input operand 917 or weight operand 927 may be sparse, meaning it may include one or more zero values. In some embodiments, the PE does not receive or process any activation-weight pair in which the activation or weight is zero. Skipping such activation-weight pairs can accelerate the computation in the PE without impairing the accuracy in the output as the input channels are not separable in the output tensor 930. Even though FIG. 9 shows one filter 920 and one output channel, multiple filters 920 may be used in the standard convolution 900 in other embodiments and result in multiple output channels. The number of output channels may equal the number of filters 920 used in the standard convolution 900.

### Example Channel-Separable Operations

FIG. 10 illustrates an example depthwise convolution 1000, in accordance with various embodiments. The depthwise convolution 1000 may be a convolution in a convolutional layer of a DNN, e.g., a convolutional layer 110 in FIG. 1. The depthwise convolution 1000 may be an example of the depthwise convolution 183 in FIG. 1. The depthwise convolution 1000 is executed on input data including an input tensor 1010 and a filter 1020. A result of the depthwise convolution 1000 is an output tensor 1030. In some embodiments, the depthwise convolution 1000 is performed by a DNN accelerator including one or more compute block. An example of the DNN accelerator may be the DNN accelerator 200 in FIG. 2. An example of the compute blocks may be the compute block 300 in FIG. 3.

In the embodiments of FIG. 10, the input tensor 1010 includes activations (also referred to as “input activations,” “elements,” or “input elements”) arranged in a 3D matrix. An activation in the input tensor 1010 is a data point in the input tensor 1010. The input tensor 1010 has a spatial size Hᵢₙ × Wᵢₙ × Cᵢₙ, where Hᵢₙ is the height of the 3D matrix (i.e., the length along the Y axis, which indicates the number of activations in a column in the 10D matrix of each input channel), Wᵢₙ is the width of the 3D matrix (i.e., the length along the X axis, which indicates the number of activations in a row in the 10D matrix of each input channel), and Cᵢₙ is the depth of the 3D matrix (i.e., the length along the Z axis, which indicates the number of input channels). For purpose of simplicity and illustration, Hᵢₙ and Wᵢₙ are both 7, i.e., the input tensor 1010 includes a 7×7 2D matrix for each input channel. Each input element in the input tensor 1010 may be represented by a (X, Y, Z) coordinate. In other embodiments, the height, width, or depth of the input tensor 1010 may be different.

The filter 1020 includes weights arranged in a 3D matrix. The values of the weights may be determined through training the DNN. A filter 1020 has a spatial size H_{f} × W_{f} × Cᵢₙ, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and Cᵢₙ is the depth of the filter (i.e., the length along the Z axis, which indicates the number of input channels). For purpose of simplicity and illustration, the filter 1020 has a 3×3 kernel for each input channel. In other embodiments, the height, width, or depth of the filter 1020 may be different. The spatial size of the convolutional kernels is smaller than the spatial size of the 2D matrix of each input channel in the input tensor 1010.

An activation or weight may take one or more bytes in a memory. The number of bytes for an activation or weight may depend on the data format. For example, when the activation or weight has an integral format (e.g., INT8), the activation takes one byte. When the activation or weight has a floating-point format (e.g., FP16 or BF16), the activation or weight takes two bytes. Other data formats may be used for activations or weights.

In the depthwise convolution 1000, the filter 1020 slides across the input tensor 1010 and generates a 3D matrix, i.e., the output tensor 1030. In the embodiments of FIG. 10, the output tensor 1030 has a spatial size of Hₒᵤₜ × Wₒᵤₜ × Cᵢₙ where Hₒᵤₜ is the height of the 3D matrix (i.e., the length along the Y axis, which indicates the number of activations in a column in the 2D matrix of each input channel), Wᵢₙ is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). Different from the standard convolution 900, the depthwise convolution 1000 is a channel-separable operation, as the input channels are still separated in the output tensor 1030.

As a part of the depthwise convolution 1000, MAC operations can be performed on a 3×3×3 subtensor 1015 (which is highlighted with dot patterns in FIG. 10) in the input tensor 1010 and the filter 1020. The subtensor 1015 and the filter 1020 have the same spatial size. The result of the MAC operations on the subtensor 1015 and one filter 1020 is a vector 1035, which is highlighted with dot patterns in FIG. 10, in the output tensor 1030. The vector 1035 includes a sequence of output activations, each of which is in a different input channel. The vector 1035 may be an output operand.

After the vector 1035 is produced, further MAC operations are performed to produce additional output operands till the entire output tensor 1030 is produced. For instance, the filter 1020 may move over the input tensor 1010 along the X axis or the Y axis, and MAC operations can be performed on the filter 1020 and another subtensor in the input tensor 1010 (the subtensor has the same size as the filter 1020). The amount of movement of a filter 1020 over the input tensor 1010 during different compute rounds of the convolution is referred to as the stride size of the convolution. The stride size may be 1 (i.e., the amount of movement of the filter 1020 is one activation), 2 (i.e., the amount of movement of the filter 1020 is two activations), and so on. The height and width of the output tensor 1030 may be determined based on the stride size.

In some embodiments, MAC operations on a 3×3×3 subtensor (e.g., the subtensor 1015) and a filter 1020 may be performed by a plurality of PEs, such as PEs in the PE array 340. One or more PEs may receive an input operand (e.g., an input operand 1017 shown in FIG. 10) and a weight operand (e.g., the weight operand 1027 shown in FIG. 10). The input operand 1017 includes a sequence of activations having the same (X, Y) coordinate but different Z coordinates. Similarly, the weight operand 1027 includes a sequence of weights having the same (X, Y) coordinate but different Z coordinates. The length of the input operand 1017 may be the same as the length of the weight operand 1027. Activations in the input operand 1017 and weights in the weight operand 1027 may be sequentially fed into a PE. The PE may receive an activation-weight pair of at a time and multiple the activation and the weight. The position of the activation in the input operand 1017 may match the position of the weight in the weight operand 1027. As the depthwise convolution 1000 is a channel-separable operation, zero-valued activations or weights should not be skipped as they can contribute to the output.

FIG. 11 illustrates an example group convolution 1100, in accordance with various embodiments. The group convolution 1100 may be a convolution in a convolutional layer of a DNN, e.g., a convolutional layer 110 in FIG. 1. The group convolution 1100 is executed on input data including an input tensor 1110 and filters 1125 and 1127. A result of the group convolution 1100 is an output tensor 1130. In some embodiments, the group convolution 1100 is performed by a DNN accelerator including one or more compute block. An example of the DNN accelerator may be the DNN accelerator 200 in FIG. 2. An example of the compute blocks may be the compute block 300 in FIG. 3.

In the embodiments of FIG. 11, the input tensor 1110 includes activations (also referred to as “input activations,” “elements,” or “input elements”) arranged in a 3D matrix. An activation in the input tensor 1110 is a data point in the input tensor 1110. The input tensor 1110 has a spatial size Hᵢₙ × Wᵢₙ × Cᵢₙ, where Hᵢₙ is the height of the 3D matrix (i.e., the length along the Y axis, which indicates the number of activations in a column in the 11D matrix of each input channel), Wᵢₙ is the width of the 3D matrix (i.e., the length along the X axis, which indicates the number of activations in a row in the 11D matrix of each input channel), and Cᵢₙ is the depth of the 3D matrix (i.e., the length along the Z axis, which indicates the number of input channels). For purpose of simplicity and illustration, Hᵢₙ and Wᵢₙ are both 7, i.e., the input tensor 1110 includes a 7×7 2D matrix for each input channel. Each input element in the input tensor 1110 may be represented by a (X, Y, Z) coordinate. In other embodiments, the height, width, or depth of the input tensor 1110 may be different.

The group convolution 1100 has a group size of 2, meaning the group convolution 1100 includes two convolutions. The input tensor 1110 is divided into two subtensors 1115 and 1117, each having a spatial size of Hᵢₙ × Wᵢₙ × Cᵢₙ/2. One convolution (the first convolution) is on the subtensor 1115 and the filters 1125 (individually referred to as “filter 1125”). The other convolution (the second convolution) is on the subtensor 1117 and the filters 1127 (individually referred to as “filter 1127”). There are a number Cₒᵤₜ/2 filters 1125 and a number Cₒᵤₜ/2 filters 1127 in the emboidments of FIG. 11, where Cₒᵤₜ denotes the number of output channels in the output tensor 1130. Each filter 1125 or 1127 has a spatial size of H_{f} × W_{f} × Cᵢₙ, where H_{f} is the height of the filter 1125 or 1127 (i.e., the length along the Y axis, which indicates the number of weights in a column in each kernel), W_{f} is the width of the filter 1125 or 1127 (i.e., the length along the X axis, which indicates the number of weights in a row in each kernel), and Cᵢₙ is the depth of the filter 1125 or 1127 (i.e., the length along the Z axis, which indicates the number of input channels). The spatial size of the convolutional kernels is smaller than the spatial size of the 2D matrix of each input channel in the input tensor 1110. For purpose of simplicity and illustration, the filter 1125 or 1127 has a 3×3 kernel for each input channel. In other embodiments, the height, width, or depth of the filter 1125 or 1127 may be different. Also, the filters 1127 may include different weights from the filters 1125.

An activation or weight may take one or more bytes in a memory. The number of bytes for an activation or weight may depend on the data format. For example, when the activation or weight has an integral format (e.g., INT8), the activation takes one byte. When the activation or weight has a floating-point format (e.g., FP16 or BF16), the activation or weight takes two bytes. Other data formats may be used for activations or weights.

In the first convolution of the group convolution 1100, each filter 1125 slides across the subtensor 1115 and generates a 3D matrix, i.e., a subtensor 1135 in the output tensor 1130. In the embodiments of FIG. 11, the subtensor 1135 has a spatial size of Hₒᵤₜ × Wₒᵤₜ × Cₒᵤₜ/2 where Hₒᵤₜ is the height of the 3D matrix (i.e., the length along the Y axis, which indicates the number of activations in a column in the 2D matrix of each input channel), Wₒᵤₜ is the width of the 3D matrix (i.e., the length along the X axis, which indicates the number of activations in a row in the 2D matrix of each input channel), and Cₒᵤₜ is the depth of the output tensor 1130 (i.e., the length along the Z axis, which indicates the number of output channels) with Cₒᵤₜ/2 being the depth of the subtensor 1135.

In the second convolution of the group convolution 1100, each filter 1127 slides across the subtensor 1117 and generates a 3D matrix, i.e., a subtensor 1137 in the output tensor 1130. In the embodiments of FIG. 11, the subtensor 1137 has a spatial size of Hₒᵤₜ × Wₒᵤₜ × Cₒᵤₜ/2 where Hₒᵤₜ is the height of the 3D matrix (i.e., the length along the Y axis, which indicates the number of activations in a column in the 2D matrix of each input channel), Wₒᵤₜ is the width of the 3D matrix (i.e., the length along the X axis, which indicates the number of activations in a row in the 2D matrix of each input channel), and Cₒᵤₜ is the depth of the output tensor 1130 (i.e., the length along the Z axis, which indicates the number of output channels) with Cₒᵤₜ/2 being the depth of the subtensor 1137.

As the input tensor 1110 is split into multiple subtensors (i.e., the subtensor 1115 and 1117 in FIG. 11) and the subtensors 1115 and 1117 are used in separate convolutions, a single output activation in the output tensor 1130 is computed based on input activations from half of the input channels in the input tensor 1110, i.e., a number Cᵢₙ/2 input channels instead of a number Cᵢₙ input channels. For each pair of (X, Y) coordinates, the input activations (the total number of which is Cᵢₙ) are used to compute two output activations. In embodiments where the group convolution 1110 has a group size of N (where N is an integer greater than two), the number Cᵢₙ input activations having the same (X, Y) coordinates may be used to computer N output activations. Thus, the group convolution 1100 is a channel-separable operation. The group convolution 1100 may be executed by a compute block that can execute standard convolution or depthwise convolution. In some embodiments, the first convolution and the second convolution are each a depthwise convolution.

FIG. 12 illustrates an example depthwise convolution in a PE 1200, in accordance with various embodiments. The PE 1200 may be an embodiment of PEs in the PE array 340. For purpose of illustration, the PE 1200 includes four input register files 1210 (collectively referred to as “input register files 1210” or “input register file 1210”), four weight register files 1220 (collectively referred to as “weight register files 1220” or “weight register file 1220”), four multipliers 1230A-D (collectively referred to as “multipliers 1230” or “multiplier 1230”), an internal adder assembly 1240 that includes three internal adders 1245A-C collectively referred to as “internal adders 1245” or “internal adder 1245”), and an output register file 1250. In other embodiments, the PE 1200 may include a different number of input register files 1210, weight register files 1220, multipliers 1230, internal adders 1245, or output register file 1250.

In the embodiments of FIG. 12, each input register file 1210 stores an input operand that includes 16 input elements, IF0-IF15, for 16 depthwise channels. Each weight register file 1220 stores a weight operand that includes 16 weights, FL0-FL15. Each multiplier 1230 receives an input operand from an input register file 1210 and a weight from a weight register file 1220. The multiplier 1230 performs 16 cycles of multiplication operations. In each cycle, the multiplier 1230 multiplies an input element and a weight and generates a product. The multiplier 1230 processes the input elements and weights sequentially based on their positions in the input operand and weight operand. For instance, the multiplier 1230 multiples IF0 and FL0 in the first cycle, multiples IF1 and FL1 in the second cycle, and continues till it finishes the multiplication of IF15 and FL15 in the sixteenth cycle. The multipliers 1230 may operate simultaneously. In the embodiments of FIG. 12, all the input register files 1210 and all the weight register files 1220 store data and all the multipliers 1230 are active. In other embodiments, one or more of the input register files 1210 or of the weight register files 1220 may be empty, and one or more of the multipliers 1230 may be inactive.

The products generated by the multipliers 1230 are fed into the internal adder assembly 1240. The internal adder assembly 1240 performs an intra row-wise reduction. As shown in FIG. 12, the internal adders 1245 are arranged into two tiers in the internal adder assembly 1240, where the internal adders 1245A and 1245B are in the first tier, and the internal adder 1245C is in the second tier. The internal adder 1245A receives products from the multipliers 1230A and 1230B and performs accumulation operations on these products. In some embodiments, the internal adder 1245A performs 16 cycles of accumulation operation, each of which corresponds to a different depthwise channel and is an accumulation of products for the corresponding depthwise channel. For instance, in the first cycle, the internal adder 1245A accumulates the product of IF0 times FL0 from the multiplier 1230A and the product of IF0 times FL0 from the multiplier 1230B. In the second cycle of accumulation operation, the internal adder 1245A accumulates the product of IF1 times FL1 from the multiplier 1230A and the product of IF1 times FL1 from the multiplier 1230B, and so on. Similarly, the internal adder 1245B receives products from the multipliers 1230C and 1230D and may perform 16 cycles of accumulation operation on these products. The internal adders 1245A and 1245B may operate simultaneously. The internal adder assembly 1240 may perform an intra row-wise reduction within the PE 1200 during the depthwise convolution.

The sums generated by the internal adders 1245A and 1245B are fed to the internal adder 1245C. In some embodiments, the internal adder 1245C performs 16 cycles of accumulation operation, each of which corresponds to a different depthwise channel and is an accumulation of sums, which are the internal adders 1245A and 1245B, for the corresponding depthwise channel. The internal adder 1245C outputs an output operand that is stored in the output register file 1250 of the PE 1200. The output operand includes 16 output elements OF0-OF16. The output operand may be a portion of an OFM of the depthwise convolution. Each output element may correspond to a different depthwise channel.

Through the accumulation operations by the internal adders 1245A-C, the internal adder assembly 1240 performs a reduction within a row of the kernel, i.e., intra row-wise reduction. In an example where the depthwise convolution is 3×3s1 (e.g., the depthwise convolution described above in conjunction with FIGS. 6 and 7A-I), the internal adder assembly 1240 can perform a reduction of 3 points within a row of the 3x3 kernel and generates a sum that equals X0Y0 × FX0FY0 + X1Y0 × FX1FY0 + X2Y0 × FX2FY0 for each of the 16 depthwise channels.

In some embodiments, the size of an output element may be 1 byte, and the output register file 1250 has a storage capacity of 16 bytes or more. As the output register file 1250 can store 16 output elements at a time, the PE 1200 can receive the 16 depthwise channels to compute and store 16 output elements without having to perform any reduction in the Z direction. This is more advantageous than conventional DNN accelerators, which processes a single output element at a time within a single PE while consuming all the input channels associated with the generation of that output element by distributing the input channels across multiple multipliers. Such DNN accelerators may operate well for standard convolutions, but are inefficient for depthwise convolutions, as the number of input channels in depthwise convolution that needs to be accumulated is 1 (depthwise convolution does not include accumulation across multiple input channels) and hence usually just 1 of the multipliers are active at a time.

In addition to the more efficient depthwise convolution, the PE 1200 can also perform standard convolutions. For instance, one or more of the internal adders 1245 may perform an accumulation across the 16 channels and generate a single output point. In some embodiments, the PE 1200 may have a depthwise convolution mode and a standard convolution mode. The PE 1200 performs depthwise convolutions when it is in the depthwise convolution mode and performs standard convolutions when it is in the standard convolution mode.

In addition to the intra row-wise reduction, a depthwise convolution may also include inter row-wise reduction across PEs within a PE column. As mentioned above, such inter row-wise reduction may be performed by using an external adder assembly.

In addition to depthwise convolution and group convolution, pooling layers may also have channel-separable operations. As mentioned above, pooling operations can down-sample a feature map without reducing the number of channels. In some embodiments, a pooling layer receives an output tensor of a convolution layer as an input tensor of the pooling layer. A pooling operation will be performed on the input tensor to reduce the size of the input tensor and to generate an output tensor of the pooling layer. A channel-separable pooling operation may be performed on an input operand that includes a plurality of depthwise channels. The input operand may be an output operand of a depthwise convolution, e.g., one of the depthwise convolutions described above. The pooling operation is channel-separable, meaning a pooling operation may be separately performed on the input array for each of the depthwise channels. For instance, for each depthwise channel, an output element is generated from a window in the X and Y dimensions. The input elements may be organized in a similar manner to depthwise convolution with different X coordinates across different input register files within a PE and different Y coordinates across different PEs. Successive separable channels, with one channel being evaluated per cycle, may occupy consecutive register file entries.

FIG. 13 illustrates an example channel-separable pooling operation within a PE 1300, in accordance with various embodiments. The PE 1300 may be an embodiment of PEs in the PE array 340. The channel-separable pooling operation in the embodiments of FIG. 13 may determine a value from a fixed window in the X and Y dimensions through an entire tensor volume without changing the Z dimension. As shown in FIG. 13, the PE 1300 includes an internal pooling assembly 1310, input register files 1330A-D (collectively referred to as “input register files 1330” or “input register file 1330”), and an output register file 1340.

Each input register file 1330 stores an input operand that includes 13 input elements IF0-IF15. Each input element corresponds to a different depthwise channel. The 13 input elements of each input operand may be fed subsequentially into the internal pooling assembly 1310. Each input element or weight may be stored in a storage unit of the corresponding register file. The storage unit may have a size of a byte. The input element or weight may be an integer, e.g., in the data format of INT8.

The internal pooling assembly 1310 performs pooling operations on the input operands from the input register files 1330. In an embodiment, the pooling operations are max pooling operations, and the internal pooling assembly 1310 may take a maximum value from a fixed window in the X and Y dimensions through an entire tensor volume without changing the Z dimension. In another embodiment, the pooling operations are average pooling operations, and the internal pooling assembly 1310 may determine an average of a fixed window in the X and Y dimensions through an entire tensor volume without changing the Z dimension. In other embodiments, the internal pooling assembly 1310 may perform other types of pooling operations.

The internal pooling assembly 1310 includes internal pooling operators 1320A-C (collectively referred to as “internal pooling operators 1320” or “internal pooling operator 1320”). The internal pooling operators 1320 are arranged in two tiers. The first tier includes the internal pooling operators 1320A and 1320B. The second tier includes the internal pooling operator 1320C. Each of the internal pooling operators 1320 in the first tier receives two input operands from two input register files 1330. For instance, the internal pooling operator 1320A receives the input operands from the input register files 1310A and 1310B. The internal pooling operator 1320A performs 13 cycles of pooling operations. In each cycle, the internal pooling operator 1320A performs a pooling operation on an input element from the input register file 1310A and an input element from the input register file 1310B. For instance, internal pooling operator 1320A selects the input element that has a greater value or determine an average value of the two input elements. The two input elements, which are used in each cycle, correspond to the same depthwise channel. Accordingly, the internal pooling operator 1320A generate an output operand that includes 13 elements, each of which corresponds to a different depthwise channel.

Similarly, the internal pooling operator 1320B receives the input operands from the input register files 1310C and 1310D, and performs 13 cycles of pooling operations on the two input operands, each cycle of which includes a pooling operation on an input element from the input register file 1310A and an input element from the input register file 1310B. The internal pooling operator 1320B generate an output operand that includes 13 elements.

The output operands of the internal pooling operators 1320A and 1320B are provided to the internal pooling operator 1320C as two input operands of the internal pooling operator 1320C. The internal pooling operator 1320C performs 13 cycles of pooling operations on the two input operands. In each cycle, the internal pooling operator 1320C may compare an input element from the internal pooling operator 1320A and an input element from the internal pooling operator 1320B and selects the input element having a greater value, or determine an average value of the two input elements. The internal pooling operator 1320B generate an output operand that includes 13 elements OF0-OF16, each of which corresponds to a depthwise channel. The internal pooling assembly 1310 reduces the four input operands in the input register files 1330 into one output operand in the output register file 1340.

FIG. 14 illustrates another example channel-separable pooling operation in a PE 1400, in accordance with various embodiments. The PE 1400 may be an embodiment of PEs in the PE array 340. The channel-separable pooling operation in the embodiments of FIG. 14 may determine a value from a fixed window in the X and Y dimensions through an entire tensor volume without changing the Z dimension. As shown in FIG. 14, the PE 1400 includes an internal pooling operator 1410, input register files 1430A-D (collectively referred to as “input register files 1430” or “input register file 1430”), and two output register files 1440.

In the embodiments of FIG. 14, two input register files 1430 store an input operand that includes 16 input elements IF0-IF15, i.e., the four input register files 1430 store two input operands. Each input element corresponds to a different depthwise channel. The 16 input elements of each input operand may be fed subsequentially into the internal pooling operator 1410, e.g., through a concatenating module. Each input element or weight may be stored in two storage units of the corresponding register file. A storage unit may have a size of a byte. The input element or weight may be a FP number, e.g., in the data format of FP16 or BF 16.

The internal pooling operator 1410 performs pooling operations on the two input operands from the input register files 1430. In an embodiment, the pooling operations are max pooling operations, and the internal pooling operator 1410 may take a maximum value from a fixed window in the X and Y dimensions through an entire tensor volume without changing the Z dimension. In another embodiment, the pooling operations are average pooling operations, and the internal pooling operator 1410 may determine an average of a fixed window in the X and Y dimensions through an entire tensor volume without changing the Z dimension. In other embodiments, the internal pooling operator 1410 may perform other types of pooling operations. For instance, the internal pooling operator 1420 performs 16 cycles of pooling operations. In each cycle, the internal pooling operator 1420A performs a pooling operation on an input element of the first input operand, which is from the input register files 1410A and 1410B, and an input element of the second input operand, which is from the input register files 1410C and 1410D. The internal pooling operator 1420 may select the input element that has a greater value or determine an average value of the two input elements. The two input elements, which are used in each cycle, correspond to the same depthwise channel. Accordingly, the internal pooling operator 1420A generate an output operand that includes 16 elements OF0-OF15, each of which corresponds to a different depthwise channel. The output operand can be stored in the output register files 1440.

In some embodiments (e.g., embodiments where the channel-separatable pooling is average pooling), a PE used for channel-separatable pooling may be an embodiment of a PE that can be used for depthwise convolution. For example, a multiplier in the PE may multiply each input element of an input operand with 1, so the product is the input element. The internal adder assembly in the PE may perform accumulation operations on the products generated by the multipliers in the PE. A divider, which may be in the PE or outside the PE, may perform dividing operations on the output of the internal adder assembly, e.g., dividing each output element from the internal adder assembly by a predetermined number. The predetermined number may be the number of input operands received by the internal adder assembly.

FIG. 15 illustrates an example channel-separable elementwise addition in a PE 1500, in accordance with various embodiments. The PE 1500 may be an embodiment of PEs in the PE array 340. Elementwise add operations may take two input tensors and performs a vector addition or perform a vector addition after an initial scalar multiplication. The dimensions of the two input tensors may be identical. Separate scale values can be applied to one or both input tensors. The channel-separable elementwise addition illustrated in FIG. 15 involves scale values. The size of the scale value is 8 bits, i.e., a byte, which is the same as the size of an input element. The PE 1500 has the same or similar components as a PE that can be used for depthwise convolution. As shown in FIG. 15, the PE 1500 includes four input register files 1510 (collectively referred to as “input register files 1510” or “input register file 1510”), four scale register files 1520 (collectively referred to as “scale register files 1520” or “scale register file 1520”), four multipliers 1530A-D (collectively referred to as “multipliers 1530” or “multiplier 1530”), an internal adder assembly 1540 that includes three internal adders 1545A-C collectively referred to as “internal adders 1545” or “internal adder 1545”), and an output register file 1550. In other embodiments, the PE 1500 may include a different number of input register files 1510, scale register files 1520, multipliers 1530, internal adders 1545, or output register file 1550.

The input register file 1510A stores a first input operand, which is from one of the two input tensor. The input register file 1510C stores a second input operand, which is from the other one of the two input tensor. Each input operand includes 16 input elements, IF0-IF15, each of which corresponds to a different depthwise channel. The input register files 1510B and 1510D are empty. The scale register files 1520A and 1520C each store a vector of 16 scale values: SV0-SV15. The scale values may be one or more fixed values, which may be determined by training the DNN.

The multiplier 1530A performs multiplication operations on the first input operand and the vector of scale values from the scale register file 1520A. Similarly, the multiplier 1530B performs multiplication operations on the second input operand and the vector of scale values from the scale register file 1520B. The multipliers 1530B and 1530D are inactive.

The products generated through the multiplication operations are fed into the internal adder assembly 1540. As the multipliers 1530B and 1530D are inactive, the values provided to the internal adder assembly 1540 from the multipliers 1530B and 1530D may to zero. The internal adder assembly 1540 includes internal adders 1545A-C, each of which can perform channel-separable accumulation operations, which are similar as the accumulation operations of the internal adders 1045 described above in conjunction with FIG. 10. The internal adder assembly 1040 outputs an output operand that includes 16 output elements OF0-OF 15. The output operand is stored in the output register file 1550.

In embodiments where the elementwise add operation does not involve scale values, the values stored in the scale register files 1520A and 1520C can be 1, so that the output of the multipliers 1530A and 1530C will be the input operands themselves.

FIG. 16 illustrates another example channel-separable elementwise addition in a PE 1600, in accordance with various embodiments. The PE 1600 may be an embodiment of PEs in the PE array 340. The channel-separable elementwise addition involves scale values. The size of the scale value is 16 bits, i.e., 2 bytes, which is twice the size of an input element. The PE 1600 has the same or similar components as a PE that can be used for depthwise convolution. As shown in FIG. 16, the PE 1600 includes four input register files 1610 (collectively referred to as “input register files 1610” or “input register file 1610”), four scale register files 1620 (collectively referred to as “scale register files 1620” or “scale register file 1620”), four multipliers 1630A-D (collectively referred to as “multipliers 1630” or “multiplier 1630”), an internal adder assembly 1640 that includes three internal adders 1645A-C collectively referred to as “internal adders 1645” or “internal adder 1645”) and two bit shifters 1643A and 1643B, and an output register file 1650. In other embodiments, the PE 1600 may include a different number of input register files 1610, scale register files 1620, multipliers 1630, internal adders 1645, or output register file 1650.

In FIG. 16, each input register file 1610 stores an input operand. The input register files 1610A and 1610B store the same input operand (e.g., a first input operand from one of the two input tensors), and the input register files 1610A and 1610B store the same input operand (e.g., a second input operand from the other one of the two input tensors). The scale register files 1620A and 1620B each store a half of a scale vector. The scale register file 1620A stores the lower bytes SV0-SV7, and the scale register file 1620B stores the higher bytes SV8-SV15. Similarly, the scale register files 1620C and 1620D each store a half of another scale vector. The scale register file 1620C stores the lower bytes SV0-SV7, and the scale register file 1620D stores the higher bytes SV8-SV15.

The multiplier 1630A performs multiplication operations on the first input operand from the input register file 1610A and the first half of the first scale vector from the scale register file 1620A. The multiplier 1630B performs multiplication operations on the first input operand from the input register file 1610B and the second half of the first scale vector from the scale register file 1620B. Similarly, the multiplier 1630C performs multiplication operations on the second input operand from the input register file 1610C and the first half of the second scale vector from the scale register file 1620C, and the multiplier 1630D performs multiplication operations on the second input operand from the input register file 1610D and the second half of the second scale vector from the scale register file 1620D.

The products generated by the four multipliers 1630 are fed into the internal adder assembly 1640. The products from the multipliers 1630A and 1630C are directly provided to the internal adder 1645A and 1645B, respectively. The products from the multipliers 1630B and 1630D are first provided to the bit shifters 1643A and 1643B, respectively. The bit shifters 1643A can change the positions of the products from the multipliers 1630B, which are then combined with the products from the multipliers 1630A by the internal adder 1645A. Similarly, the bit shifters 1643B can change the positions of the products from the multipliers 1630D, which are then combined with the products from the multipliers 1630C by the internal adder 1645B. The sums from the internal adders 1645A and 1645B are then provided to the internal adder 1645C, which generate an output operand including 16 output elements OF0-OF15. The output operand is stored in the output register file 1650.

FIG. 17 illustrates an example channel-separable elementwise multiplication in a PE 1700, in accordance with various embodiments. The PE 1700 may be an embodiment of PEs in the PE array 340. The channel-separable elementwise multiplication is performed on two input tensors, which may be from two DNN layers. The two input tensors may have the same dimensions. The result of the channel-separable elementwise multiplication may be a new tensor (also referred to as output tensor) with the same dimensions as the input tensors. The output tensor includes a plurality of scalar values. Each scalar value may be a product of a first scale value in the first input tensor and a second scalar value in the second input tensor.

As shown in FIG. 17, the PE 1710 includes four first input register files 1713A-D (collectively referred to as “first input register files 1713” or “first input register file 1713”), four second input register files 1715A-D (collectively referred to as “second input register files 1715” or “second input register file 1715”), and four multipliers 1717A-D (collectively referred to as “multipliers 1717” or “multiplier 1717”). Even though not shown in FIG. 17A, the PE 1710 may include other components, such as an internal adder assembly, an output register file, etc. The internal adder assembly may not be used for the channel-separable elementwise multiplication. Also, the PE 1710 may include a different number of first input register files or second input register files. The PE 1710 may be the same or similar to a PE used to perform depthwise convolutions.

The first input tensor and the second input tensor may be separately loaded to the first input register files 1713 and the second input register files 1715, respectively. As shown in FIG. 17, each first input register file 1713 stores a first input operand, which may be a portion of the first input tensor. Each second input register file 1715 stores a second input operand, which may be a portion of the second input tensor. Each multiplier 1717 performs multiplication operations, e.g., 16 sequential cycles of multiplication, on a first input operand and a second input operand. Each cycle may be a multiplication of an input element in the first input operand and an input element in the second input operand. The two input elements may correspond to a same depthwise channel. The product produced by multiplying each pair of input elements may be an output element of an output operand, which can be written into an output register file of the PE 1710. The existence of multiple register files 1713 or 1715 for each input tensor and multiple multipliers 1717 in the PE 1710 allows the PE 1710 to implement N parallel contexts, where N is an integer and equals the number of multipliers 1717 (N=4 in FIG. 17). A context may refer to individual partial sums for different output elements. This is possible as the PE architecture allows bypassing the internal adder assembly and write the contexts in parallel to the output register file. Furthermore, the channel-separable elementwise multiplication may not need external adders.

Compared with conventional elementwise multiplication that produces a single context per clock cycle, the PE 1710 is more advantageous. In conventional elementwise multiplication, subsequent channels can be fed to different multipliers in parallel to produce a single context. Then the channels are reduced through adders before writing to the output register file. The result of accumulating across channels through the adders would produce an incorrect elementwise multiplication result and hence only a single multiplier per PE can be used. In contrast, in the embodiments of FIG. 17, four multipliers 1717 can be utilized within the PE 1710, the throughput will be four times that of the conventional elementwise multiplication.

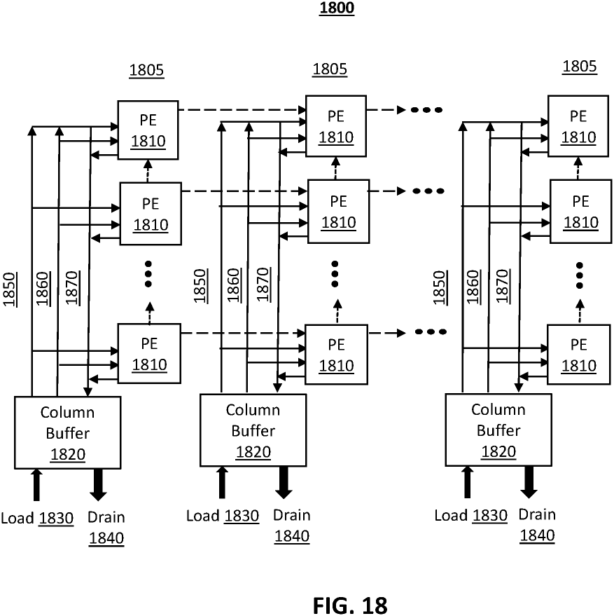

FIG. 18 illustrates a PE array 1800, in accordance with various embodiments. The PE array 1800 may be an embodiment of the PE array 340 in FIG. 3 or an embodiment of the PE array 401 in FIG. 4. The PE array 1800 includes a plurality of PEs 1810 (individually referred to as “PE 1810”). The PEs 1810 can perform MAC operations in convolutions. The PEs 1810 can also perform other types of deep learning operations. The PEs 1810 may also be referred to as neurons in the DNN. A PE 1810 may be an example of a PE 430 in FIG. 4, PE 1200 in FIG. 12, PE 1300 in FIG. 13, PE1400 in FIG. 14, PE 1500 in FIG. 15, PE 1600 in FIG. 16, or PE 1700 in FIG. 17. Each PE 1810 has two input signals 1850 and 1860 and an output signal 1870. The input signal 1850 is at least a portion of an IFM to the layer. The input signal 1860 is at least a portion of a filter of the layer. In some embodiments, the input signal 1850 of a PE 1810 includes one or more input operands, and the input signal 1860 includes one or more weight operand.

Each PE 1810 performs an MAC operation on the input signals 1850 and 1860 and outputs the output signal 1870, which is a result of the MAC operation. Some or all of the input signals 1850 and 1860 and the output signal 1870 may be in an integer format, such as INT8, or floating-point format, such as FP16 or BF16. For purpose of simplicity and illustration, the input signals and output signal of all the PEs 1810 have the same reference numbers, but the PEs 1810 may receive different input signals and output different output signals from each other. Also, a PE 1810 may be different from another PE 1810, e.g., including more, fewer, or different components.

As shown in FIG. 18, the PEs 1810 are connected to each other, as indicated by the dash arrows in FIG. 18. The output signal 1870 of an PE 1810 may be sent to many other PEs 1810 (and possibly back to itself) as input signals via the interconnections between PEs 1810. In some embodiments, the output signal 1870 of an PE 1810 may incorporate the output signals of one or more other PEs 1810 through an accumulate operation of the PE 1810 and generates an internal partial sum of the PE array. More details about the PEs 1810 are described below in conjunction with FIG. 18B.

In the embodiments of FIG. 18, the PEs 1810 are arranged into columns 1805 (individually referred to as “column 1805”). The input and weights of the layer may be distributed to the PEs 1810 based on the columns 1805. Each column 1805 has a column buffer 1820. The column buffer 1820 stores data provided to the PEs 1810 in the column 1805 for a short amount of time. The column buffer 1820 may also store data output by the last PE 1810 in the column 1805. The output of the last PE 1810 may be a sum of the MAC operations of all the PEs 1810 in the column 1805, which is a column-level internal partial sum of the PE array 1800. In other embodiments, input and weights may be distributed to the PEs 1810 based on rows in the PE array 1800. The PE array 1800 may include row buffers in lieu of column buffers 1820. A row buffer may store input signals of the PEs in the corresponding row and may also store a row-level internal partial sum of the PE array 1800.

As shown in FIG. 18, each column buffer 1820 is associated with a load 1830 and a drain 1840. The data provided to the column 1805 is transmitted to the column buffer 1820 through the load 1830, e.g., through upper memory hierarchies, e.g., the local memory 310 in FIG. 3. The data generated by the column 1805 is extracted from the column buffers 1820 through the drain 1840. A column buffer 1820 may be a datastore (or a portion of a datastore), such as the datastore 330 or 350 in FIG. 3. In some embodiments, data extracted from a column buffer 1820 is sent to upper memory hierarchies, e.g., the memory 410 in FIG. 4, through the drain operation. In some embodiments, the drain operation does not start until all the PEs 1810 in the column 1805 has finished their MAC operations. Even though not shown in FIG. 18, one or more columns 1805 may be associated with an external adder assembly.

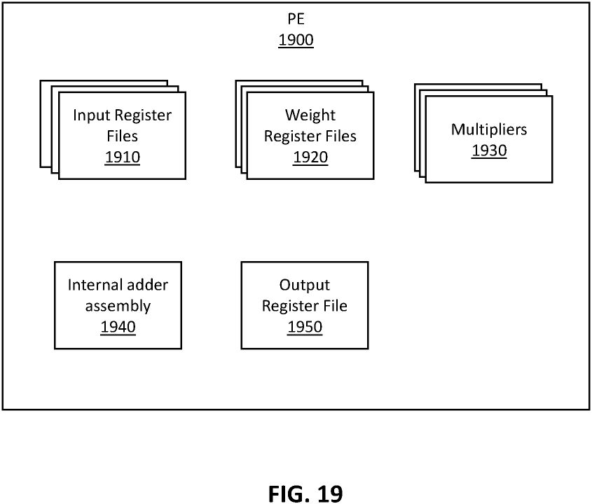

FIG. 19 is a block diagram of a PE 1900, in accordance with various embodiments. The PE 1900 may be an embodiment of the PE 1810 in FIG. 18. The PE 1900 includes input register files 1910 (individually referred to as “input register file 1910”), weight registers file 1920 (individually referred to as “weight register file 1920”), multipliers 1930 (individually referred to as “multiplier 1930”), an internal adder assembly 1940, and an output register file 1950. In other embodiments, the PE 1900 may include fewer, more, or different components. For example, the PE 1900 may include multiple output register files 1950. As another example, the PE 1900 may include a single input register file 1910, weight register file 1920, or multiplier 1930. As yet another example, the PE 1900 may include an adder in lieu of the internal adder assembly 1940.

The input register files 1910 temporarily store input operands for MAC operations by the PE 1900. In some embodiments, an input register file 1910 may store a single input operand at a time. In other embodiments, an input register file 1910 may store multiple input operand or a portion of an input operand at a time. An input operand includes a plurality of input elements (i.e., input elements) in an input tensor. The input elements of an input operand may be stored sequentially in the input register file 1910 so the input elements can be processed sequentially. In some embodiments, each input element in the input operand may be from a different input channel of the input tensor. The input operand may include an input element from each of the input channels of the input tensor, and the number of input elements in an input operand may equal the number of the input channels. The input elements in an input operand may have the same XY coordinates, which may be used as the XY coordinates of the input operand. For instance, all the input elements of an input operand may be X0Y0, X0Y1, X1Y1, etc.

The weight register file 1920 temporarily stores weight operands for MAC operations by the PE 1900. The weight operands include weights in the filters of the DNN layer. In some embodiments, the weight register file 1920 may store a single weight operand at a time. other embodiments, an input register file 1910 may store multiple weight operands or a portion of a weight operand at a time. A weight operand may include a plurality of weights. The weights of a weight operand may be stored sequentially in the weight register file 1920 so the weight can be processed sequentially. In some embodiments, for a multiplication operation that involves a weight operand and an input operand, each weight in the weight operand may correspond to an input element of the input operand. The number of weights in the weight operand may equal the number of the input elements in the input operand.

In some embodiments, a weight register file 1920 may be the same or similar as an input register file 1910, e.g., having the same size, etc. The PE 1900 may include a plurality of register files, some of which are designated as the input register files 1910 for storing input operands, some of which are designated as the weight register files 1920 for storing weight operands, and some of which are designated as the output register file 1950 for storing output operands. In other embodiments, register files in the PE 1900 may be designated for other purposes, e.g., for storing scale operands used in elementwise add operations, etc.

The multipliers 1930 perform multiplication operations on input operands and weight operands. A multiplier 1930 may perform a sequence of multiplication operations on a single input operand and a single weight operand and generates a product operand including a sequence of products. Each multiplication operation in the sequence includes multiplying an input element in the input operand and a weight in the weight operand. In some embodiments, a position (or index) of the input element in the input operand matches the position (or index) of the weight in the weight operand. For instance, the first multiplication operation is a multiplication of the first input element in the input operand and the first weight in the weight operand, the second multiplication operation is a multiplication of the second input element in the input operand and the second weight in the weight operand, the third multiplication operation is a multiplication of the third input element in the input operand and the third weight in the weight operand, and so on. The input element and weight in the same multiplication operation may correspond to the same depthwise channel, and their product may also correspond to the same depthwise channel.

Multiple multipliers 1930 may perform multiplication operations simultaneously. These multiplication operations may be referred to as a round of multiplication operations. In a round of multiplication operations by the multipliers 1930, each of the multipliers 1930 may use a different input operand and a different weight operand. The different input operands or weight operands may be stored in different register files of the PE 1900. For instance, a first multiplier 1930 uses a first input operand (e.g., stored in a first input register file 1910) and a first weight operand (e.g., stored in a first weight register file 1920), versus a second multiplier 1930 uses a second input operand (e.g., stored in a second input register file 1910) and a second weight operand (e.g., stored in a second weight register file 1920), a third multiplier 1930 uses a third input operand (e.g., stored in a third input register file 1910) and a third weight operand (e.g., stored in a third weight register file 1920), and so on. For an individual multiplier 1930, the round of multiplication operations may include a plurality of cycles. A cycle includes a multiplication operation on an input element and a weight.

The multipliers 1930 may perform multiple rounds of multiplication operations. A multiplier 1930 may use the same weight operand but different input operands in different rounds. For instance, the multiplier 1930 performs a sequence of multiplication operations on a first input operand stored in a first input register file in a first round, versus a second input operand stored in a second input register file in a second round. In the second round, a different multiplier 1930 may use the first input operand and a different weight operand to perform another sequence of multiplication operations. That way, the first input operand is reused in the second round. The first input operand may be further reused in additional rounds, e.g., by additional multipliers 1930.

The internal adder assembly 1940 includes one or more adders inside the PE 1900, i.e., internal adders. The internal adder assembly 1940 may perform accumulation operations on two or more products operands from multipliers 1930 and produce an output operand of the PE 1900. In some embodiments, the internal adders are arranged in a sequence of tiers. A tier includes one or more internal adders. For the first tier of the internal adder assembly 1940, an internal adder may receive product operands from two or more multipliers 1930 and generate a sum operand through a sequence of accumulation operations. Each accumulation operation produces a sum of two or more products, each of which is from a different multiplier 1930. The sum operand includes a sequence of sums, each of which is a result of an accumulation operation and corresponds to a depthwise channel. For the other tier(s) of the internal adder assembly 1940, an internal adder in a tier receives sum operands from the precedent tier in the sequence. Each of these number may be generated by a different internal adder in the precedent tier. A ratio of the number of internal adders in a tier to the number of internal adders in a subsequent tier may be 2:1. In some embodiments, the last tier of the internal adder assembly 1940 may include a single internal adder, which produces the output operand of the PE 1900.

The output register file 1950 stores output operands of the PE 1900. In some embodiments, the output register file 1950 may store an output operand at a time. In other embodiments, the output register file 1950 may store multiple output operand or a portion of an output operand at a time. An output operand includes a plurality of output elements in an IFM. The output elements of an output operand may be stored sequentially in the output register file 1950 so the output elements can be processed sequentially. In some embodiments, each output element in the output operand corresponds to a different depthwise channel and is an element of a different output channel of the output channel of the depthwise convolution. The number of output element in an output operand may equal the number of the depthwise channels of the depthwise convolution.

### Example Method of Dynamic Uncompression for Channel-Separable Operations

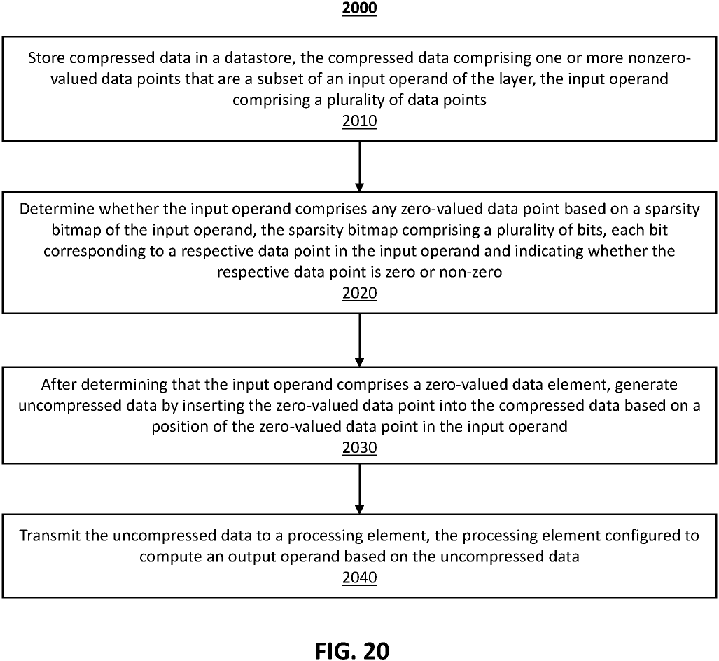

FIG. 20 is a flowchart showing a method 2000 of dynamic uncompression for channel-separable operations, in accordance with various embodiments. The method 2000 may be performed by one or more components of the compute block 300 in FIG. 3 for executing a layer of a DNN. The layer includes one or more channel-separable operations, such as depthwise convolution, group convolution, elementwise operation, channel-separable pooling operations, and so on. Although the method 2000 is described with reference to the flowchart illustrated in FIG. 20, many other methods for dynamic uncompression for channel-separable operations may alternatively be used. For example, the order of execution of the steps in FIG. 20 may be changed. As another example, some of the steps may be changed, eliminated, or combined.

The compute block 300 stores 2010 compressed data in a datastore. The compressed data comprises one or more nonzero-valued data points that are a subset of an input operand of a layer in a DNN. The input operand comprises a plurality of data points. In some embodiments, the layer is selected from a group consisting of a depthwise convolution layer, a group convolution layer, an elementwise layer, and a pooling layer.

The compute block 300 determines 2020 whether the input operand comprises any zero-valued data point based on a sparsity bitmap of the input operand. The sparsity bitmap comprising a plurality of bits. Each bit corresponds to a respective data point in the input operand and indicates whether the respective data point is zero or nonzero. In some embodiments, the input operand is a part of an IFM of the layer. The IFM comprises a plurality of channels. The plurality of data points in the input operand is in different channels of the plurality of channels.

In some embodiments, the compute block 300 determines whether the input operand comprises any zero-valued data point by determining whether any bit in the sparsity bitmap is zero. In some embodiments, the plurality of bits in the sparsity bitmap is in a sequence. The compute block 300 may also determine the position of the zero-valued data point in the input operand based on a position of the bit in the sparsity bitmap.

After determining that the input operand comprises a zero-valued data point, the compute block 300 generates 2030 uncompressed data by inserting the zero-valued data point into the compressed data based on a position of the zero-valued data point in the input operand. In some embodiments, the compute block 300 also generates a new sparsity bitmap for the uncompressed data. The new sparsity bitmap comprises a plurality of bits. Each bit has a value of one. The new sparsity bitmap can facilitate densification of the zero-valued data point so that the PE, even though implemented with sparsity acceleration logic, will process the zero-valued data point.

The compute block 300 transmits 2040 the uncompressed data to a PE, the PE configured to compute an output operand based on the uncompressed data. In some embodiments, the output operand comprises data points in two or more channels. The two or more channels may be some or all of the channels in the input operand.

In some embodiments, the compute block 300 stores the output operand in the datastore. The compute block 300 also writes a subset of the output operand from the datastore to a memory, such as the local memory 310. The subset of the output operand comprises one or more nonzero-valued data points in the output operand.

In some embodiments, the compute block 300 generates a new sparsity bitmap for the output operand. The new sparsity bitmap comprises a plurality of bits. Each bit corresponds to a respective data point in the output operand and indicates whether the respective data point in the output operand is zero or nonzero.

### Example Computing Device

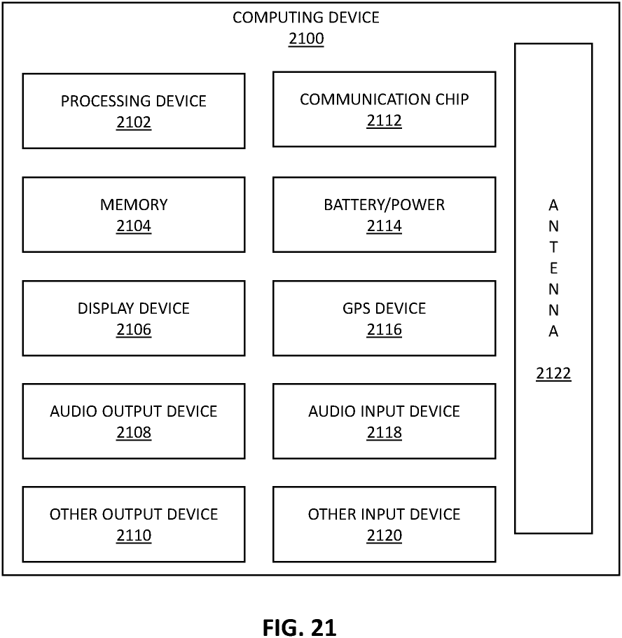

FIG. 21 is a block diagram of an example computing device 2100, in accordance with various embodiments. In some embodiments, the computing device 2100 may be used as at least part of the DNN accelerator 200 in FIG. 2. A number of components are illustrated in FIG. 21 as included in the computing device 2100, but any one or more of these components may be omitted or duplicated, as suitable for the application. In some embodiments, some or all of the components included in the computing device 2100 may be attached to one or more motherboards. In some embodiments, some or all of these components are fabricated onto a single system on a chip (SoC) die. Additionally, in various embodiments, the computing device 2100 may not include one or more of the components illustrated in FIG. 21, but the computing device 2100 may include interface circuitry for coupling to the one or more components. For example, the computing device 2100 may not include a display device 2106, but may include display device interface circuitry (e.g., a connector and driver circuitry) to which a display device 2106 may be coupled. In another set of examples, the computing device 2100 may not include an audio input device 2118 or an audio output device 2108, but may include audio input or output device interface circuitry (e.g., connectors and supporting circuitry) to which an audio input device 2118 or audio output device 2108 may be coupled.

The computing device 2100 may include a processing device 2102 (e.g., one or more processing devices). The processing device 2102 processes electronic data from registers and/or memory to transform that electronic data into other electronic data that may be stored in registers and/or memory. The computing device 2100 may include a memory 2104, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 2104 may include memory that shares a die with the processing device 2102. In some embodiments, the memory 2104 includes one or more non-transitory computer-readable media storing instructions executable to perform operations for scheduling computations in DNNs, e.g., the method 2000 described above in conjunction with FIG. 20, some operations performed by the compute block 300 described above in conjunction with FIG. 3, or some operations performed by the uncompressing module 330 described above in conjunction with FIG. 3. The instructions stored in the one or more non-transitory computer-readable media may be executed by the processing device 2102.

In some embodiments, the computing device 2100 may include a communication chip 2112 (e.g., one or more communication chips). For example, the communication chip 2112 may be configured for managing wireless communications for the transfer of data to and from the computing device 2100. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 2112 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 2112 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2112 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2112 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2112 may operate in accordance with other wireless protocols in other embodiments. The computing device 2100 may include an antenna 2122 to facilitate wireless communications and/or to receive other wireless communications (such as AM or FM radio transmissions).

In some embodiments, the communication chip 2112 may manage wired communications, such as electrical, optical, or any other suitable communication protocols (e.g., the Ethernet). As noted above, the communication chip 2112 may include multiple communication chips. For instance, a first communication chip 2112 may be dedicated to shorter-range wireless communications such as Wi-Fi or Bluetooth, and a second communication chip 2112 may be dedicated to longer-range wireless communications such as global positioning system (GPS), EDGE, GPRS, CDMA, WiMAX, LTE, EV-DO, or others. In some embodiments, a first communication chip 2112 may be dedicated to wireless communications, and a second communication chip 2112 may be dedicated to wired communications.

The computing device 2100 may include battery/power circuitry 2114. The battery/power circuitry 2114 may include one or more energy storage devices (e.g., batteries or capacitors) and/or circuitry for coupling components of the computing device 2100 to an energy source separate from the computing device 2100 (e.g., AC line power).

The computing device 2100 may include a display device 2106 (or corresponding interface circuitry, as discussed above). The display device 2106 may include any visual indicators, such as a heads-up display, a computer monitor, a projector, a touchscreen display, a liquid crystal display (LCD), a light-emitting diode display, or a flat panel display, for example.

The computing device 2100 may include an audio output device 2108 (or corresponding interface circuitry, as discussed above). The audio output device 2108 may include any device that generates an audible indicator, such as speakers, headsets, or earbuds, for example.

The computing device 2100 may include an audio input device 2118 (or corresponding interface circuitry, as discussed above). The audio input device 2118 may include any device that generates a signal representative of a sound, such as microphones, microphone arrays, or digital instruments (e.g., instruments having a musical instrument digital interface (MIDI) output).

The computing device 2100 may include a GPS device 2116 (or corresponding interface circuitry, as discussed above). The GPS device 2116 may be in communication with a satellite-based system and may receive a location of the computing device 2100, as known in the art.

The computing device 2100 may include another output device 2110 (or corresponding interface circuitry, as discussed above). Examples of the other output device 2110 may include an audio codec, a video codec, a printer, a wired or wireless transmitter for providing information to other devices, or an additional storage device.

The computing device 2100 may include another input device 2120 (or corresponding interface circuitry, as discussed above). Examples of the other input device 2120 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 2100 may have any desired form factor, such as a handheld or mobile computer system (e.g., a cell phone, a smart phone, a mobile internet device, a music player, a tablet computer, a laptop computer, a netbook computer, an ultra book computer, a PDA (personal digital assistant), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 2100 may be any other electronic device that processes data.

### Select Examples

The following paragraphs provide various examples of the embodiments disclosed herein.

Example 1 provides a method of executing a layer of a DNN, including storing compressed data in a datastore, the compressed data including one or more nonzero-valued data elements that are a subset of an input operand of the layer; determining whether the input operand includes a zero-valued data element based on a sparsity bitmap of the input operand, the input operand including a plurality of data elements, the sparsity bitmap including a plurality of bits, each bit corresponding to a respective data element in the input operand and indicating whether the respective data element is zero or nonzero; after determining that the input operand includes the zero-valued data element, generating uncompressed data by inserting the zero-valued data element into the compressed data based on a position of the zero-valued data element in the input operand; and transmitting the uncompressed data to a PE, the PE configured to compute an output operand based on the uncompressed data.

Example 2 provides the method of example 1, further including generating a new sparsity bitmap for the uncompressed data, the new sparsity bitmap including a plurality of bits, each of which has a value of one.

Example 3 provides the method of example 1 or 2, where the layer is selected from a group consisting of a depthwise convolution layer, a group convolution layer, an elementwise layer, and a pooling layer.

Example 4 provides the method of any one of examples 1-3, where the input operand is a part of an IFM of the layer, the IFM includes a plurality of channels, and the plurality of data elements in the input operand is in different channels of the plurality of channels.

Example 5 provides the method of example 4, where the output operand includes data elements in two or more of the different channels.

Example 6 provides the method of any of the preceding examples, further including storing the output operand in the datastore; and writing a subset of the output operand from the datastore to a memory, the subset of the output operand including one or more nonzero-valued data elements in the output operand.

Example 7 provides the method of any of the preceding examples, further including generating a new sparsity bitmap for the output operand, the new sparsity bitmap including a plurality of bits, each of which corresponds to a respective data element in the output operand and indicates whether the respective data element in the output operand is zero or nonzero.

Example 8 provides the method of any of the preceding examples, where determining whether the input operand includes the zero-valued data element based on the sparsity bitmap of the input operand includes determining whether a bit in the sparsity bitmap is zero.

Example 9 provides the method of any of the preceding examples, further including determining the position of the zero-valued data element in the input operand based on a position of a bit in the sparsity bitmap that corresponds to the zero-valued data element, where the plurality of bits in the sparsity bitmap is in a sequence.

Example 10 provides the method of any of the preceding examples, further including storing the sparsity bitmap in the datastore, where determining whether the input operand includes the zero-valued data element includes determining whether the input operand includes the zero-valued data element after the compressed data and the sparsity bitmap are stored in the datastore.

Example 11 provides a compute block configured to execute a layer of a DNN, the compute block including a datastore configured to store compressed data in a datastore, the compressed data including one or more nonzero-valued data elements that are a subset of an input operand of the layer; a densifying module configured to determine whether the input operand includes a zero-valued data element based on a sparsity bitmap of the input operand, the input operand including a plurality of data elements, the sparsity bitmap including a plurality of bits, each bit corresponding to a respective data element in the input operand and indicating whether the respective data element is zero or nonzero, and after determining that the input operand includes the zero-valued data element, generate uncompressed data by inserting the zero-valued data element into the compressed data based on a position of the zero-valued data element in the input operand; and a PE configured to compute an output operand based on the uncompressed data.

Example 12 provides the compute block of example 11, where the densifying module is further configured to generate a new sparsity bitmap for the uncompressed data, the new sparsity bitmap including a plurality of bits, each of which has a value of one.

Example 13 provides the compute block of example 11 or 12, where the layer is selected from a group consisting of a depthwise convolution layer, a group convolution layer, an elementwise layer, and a pooling layer.

Example 14 provides the compute block of any one of examples 11-13, where the input operand is a part of an IFM of the layer, the IFM includes a plurality of channels, and the plurality of data elements in the input operand is in different channels of the plurality of channels.

Example 15 provides the compute block of example 14, where the output operand includes data elements in two or more of the different channels.

Example 16 provides the compute block of any one of examples 11-15, where the datastore is further configured to store the output operand, the compute block further includes a memory, a subset of the output operand is written from the datastore to a memory, and the subset of the output operand includes one or more nonzero-valued data elements in the output operand.

Example 17 provides the compute block of any one of examples 11-16, where the compute block further includes a compressing module configured to generate a new sparsity bitmap for the output operand, the new sparsity bitmap including a plurality of bits, each of which corresponds to a respective data element in the output operand and indicates whether the respective data element in the output operand is zero or nonzero.

Example 18 provides the compute block of any one of examples 11-17, where the densifying module is configured to determine whether the input operand includes the zero-valued data element based on the sparsity bitmap of the input operand by determining whether a bit in the sparsity bitmap is zero.

Example 19 provides the compute block of any one of examples 11-18, where the densifying module is further configured to determine the position of the zero-valued data element in the input operand based on a position of a bit in the sparsity bitmap that corresponds to the zero-valued data element, where the plurality of bits in the sparsity bitmap is in a sequence.

Example 20 provides the compute block of any one of examples 11-19, where the datastore includes a plurality of storage units, and the densifying module is at a storage unit of the plurality of storage units.

Example 21 provides one or more non-transitory computer-readable media storing instructions executable to perform operations for executing a layer of a DNN, the operations including storing compressed data in a datastore, the compressed data including one or more nonzero-valued data elements that are a subset of an input operand of the layer; determining whether the input operand includes a zero-valued data element based on a sparsity bitmap of the input operand, the input operand including a plurality of data elements, the sparsity bitmap including a plurality of bits, each bit corresponding to a respective data element in the input operand and indicating whether the respective data element is zero or nonzero; after determining that the input operand includes the zero-valued data element, generating uncompressed data by inserting the zero-valued data element into the compressed data based on a position of the zero-valued data element in the input operand; and transmitting the uncompressed data to a PE, the PE configured to compute an output operand based on the uncompressed data.

Example 22 provides the one or more non-transitory computer-readable media of example 21, where the operations include generating a new sparsity bitmap for the uncompressed data, the new sparsity bitmap including a plurality of bits, each of which has a value of one.

Example 23 provides the one or more non-transitory computer-readable media of example 21 or 22, where the input operand is a part of an IFM of the layer, the IFM includes a plurality of channels, the plurality of data elements in the input operand is in different channels of the plurality of channels; and the output operand includes data elements in two or more of the different channels.

Example 24 provides the one or more non-transitory computer-readable media of any one of examples 21-23, where the operations further include generating a new sparsity bitmap for the output operand, the new sparsity bitmap including a plurality of bits, each of which corresponds to a respective data element in the output operand and indicates whether the respective data element in the output operand is zero or nonzero.

Example 25 provides the one or more non-transitory computer-readable media of any one of examples 21-24, where determining whether the input operand includes the zero-valued data element based on the sparsity bitmap of the input operand includes determining whether a bit in the sparsity bitmap is zero.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method of executing a layer of a deep neural network (DNN), comprising:
storing compressed data in a datastore, the compressed data comprising one or more nonzero-valued data elements that are a subset of an input operand of the layer, the input operand comprising a plurality of data elements;
determining whether the input operand comprises any zero-valued data element based on a sparsity bitmap of the input operand, the sparsity bitmap comprising a plurality of bits, each bit corresponding to a respective data element in the input operand and indicating whether the respective data element is zero or nonzero;
after determining that the input operand comprises a zero-valued data element, generating uncompressed data by inserting the zero-valued data element into the compressed data based on a position of the zero-valued data element in the input operand; and
transmitting the uncompressed data to a processing element, the processing element configured to compute an output operand based on the uncompressed data.

2. The method of claim 1, further comprising:
generating a new sparsity bitmap for the uncompressed data, the new sparsity bitmap comprising one or more bits, each of which has a value of one.

3. The method of claim 1, wherein the layer is selected from a group consisting of a depthwise convolution layer, a group convolution layer, an elementwise layer, and a pooling layer.

4. The method of claim 1, wherein the input operand is a part of an input feature map of the layer, the input feature map comprises one or more channels, and the one or more data elements in the input operand is in different channels of the one or more channels.

5. The method of claim 4, wherein the output operand comprises data elements in two or more of the different channels.

6. The method of claim 1, further comprising:
storing the output operand in the datastore; and
writing a subset of the output operand from the datastore to a memory, the subset of the output operand comprising one or more nonzero-valued data elements in the output operand.

7. The method of claim 1, further comprising:
generating a new sparsity bitmap for the output operand, the new sparsity bitmap comprising one or more bits, each of which corresponds to a respective data element in the output operand and indicates whether the respective data element in the output operand is zero or nonzero.

8. The method of claim 1, wherein determining whether the input operand comprises the zero-valued data element based on the sparsity bitmap of the input operand comprises:
determining whether a bit in the sparsity bitmap is zero.

9. The method of claim 1, further comprising:
determining the position of the zero-valued data element in the input operand based on a position of a bit in the sparsity bitmap that corresponds to the zero-valued data element,
wherein the plurality of bits in the sparsity bitmap is in a sequence.

10. The method of claim 1, further comprising:
storing the sparsity bitmap in the datastore,
wherein determining whether the input operand comprises the zero-valued data element comprises determining whether the input operand comprises the zero-valued data element after the compressed data and the sparsity bitmap are stored in the datastore.

11. A DNN accelerator configured to execute a layer of a deep neural network (DNN), the compute block comprising:
a datastore configured to store compressed data in a datastore, the compressed data comprising one or more nonzero-valued data elements that are a subset of an input operand of the layer;
a densifying module configured to:
determine whether the input operand comprises any zero-valued data element based on a sparsity bitmap of the input operand, the input operand comprising a plurality of data elements, the sparsity bitmap comprising a plurality of bits, each bit corresponding to a respective data element in the input operand and indicating whether the respective data element is zero or nonzero, and
after determining that the input operand comprises a zero-valued data element, generate uncompressed data by inserting the zero-valued data element into the compressed data based on a position of the zero-valued data element in the input operand; and
a processing element configured to compute an output operand based on the uncompressed data.

12. The DNN accelerator of claim 11, wherein the densifying module is further configured to:
generate a new sparsity bitmap for the uncompressed data, the new sparsity bitmap comprising a plurality of bits, each of which has a value of one.

13. The DNN accelerator of claim 11, wherein the layer is selected from a group consisting of a depthwise convolution layer, a group convolution layer, an elementwise layer, and a pooling layer.

14. The DNN accelerator of claim 11, wherein the input operand is a part of an input feature map of the layer, the input feature map comprises a plurality of channels, and the plurality of data elements in the input operand is in different channels of the plurality of channels.

15. The DNN accelerator of claim 14, wherein the output operand comprises data elements in two or more of the different channels.

16. One or more non-transitory computer-readable media storing instructions executable to perform operations for executing a layer of a deep neural network (DNN), the operations comprising:
storing compressed data in a datastore, the compressed data comprising one or more nonzero-valued data elements that are a subset of an input operand of the layer;
determining whether the input operand comprises any zero-valued data element based on a sparsity bitmap of the input operand, the input operand comprising a plurality of data elements, the sparsity bitmap comprising a plurality of bits, each bit corresponding to a respective data element in the input operand and indicating whether the respective data element is zero or nonzero;
after determining that the input operand comprises a zero-valued data element, generating uncompressed data by inserting the zero-valued data element into the compressed data based on a position of the zero-valued data element in the input operand; and
transmitting the uncompressed data to a processing element, the processing element configured to compute an output operand based on the uncompressed data.

17. The one or more non-transitory computer-readable media of claim 16, wherein the operations comprise:
generating a new sparsity bitmap for the uncompressed data, the new sparsity bitmap comprising a plurality of bits, each of which has a value of one.

18. The one or more non-transitory computer-readable media of claim 16, wherein:
the input operand is a part of an input feature map of the layer,
the input feature map comprises a plurality of channels,
the plurality of data elements in the input operand is in different channels of the plurality of channels; and
the output operand comprises data elements in two or more of the different channels.

19. The one or more non-transitory computer-readable media of claim 16, wherein the operations further comprise:
generating a new sparsity bitmap for the output operand, the new sparsity bitmap comprising a plurality of bits, each of which corresponds to a respective data element in the output operand and indicates whether the respective data element in the output operand is zero or nonzero.

20. The one or more non-transitory computer-readable media of claim 16, wherein determining whether the input operand comprises the zero-valued data element based on the sparsity bitmap of the input operand comprises:
determining whether a bit in the sparsity bitmap is zero.
